(19) United States
(12) Patent Application Publication
(10) Pub. No.: US 2017/0024585 A1
(43) Pub. Date: Jan. 26, 2017

(54) SECURED ELECTRONICS DEVICE

(71) Applicant: Irdeto B.V., Hoofddorp (NL)

(72) Inventors: Wim Mooij, Hoofddorp (NL); Jeroen Doumen, Hoofddorp (NL); Marcel Wijkstra, Hoofddorp (NL); John Wimer, Hoofddorp (NL)

(21) Appl. No.: 15/300,936

(22) PCT Filed: Mar. 31, 2015
(86) PCT No.: PCT/EP2015/057052

§ 371 Date: Sep. 30, 2016

(30) Foreign Application Priority Data
Mar. 31, 2014 (GB) 1405705.3

(51) Int. Cl. G06F 21/75; H04L 9/32; H04N 5/232; G06F 21/72

(52) U.S. Cl. CPC G06F 21/75; G06F 21/72; H04L 9/3271; H04N 5/23216; H04L 2209/16; H04W 76/02

(57) ABSTRACT

An electronics device comprising one or more modules that implement a security-related operation in an obfuscated manner to thereby provide the security-related operation with resistance against a hardware attack, wherein the electronics device is either (a) a printed electronics device or (b) a device created using e-beam lithography.

### FIELD OF THE INVENTION

The present invention relates to electronics devices, methods of generating electronics devices, and apparatus and computer programs for carrying out such methods.

### BACKGROUND OF THE INVENTION

“Printed electronics” techniques are well-known methods and processes used to create or manufacture complete electrical devices or circuits on various substrates by a printing process or a printing technology. The printing may use many conventional printing technologies such as screen printing, flexography, gravure, offset lithography, inkjet and 3D printing techniques. In particular, electrically functional electronic or optical inks may be deposited on the substrate to thereby form active and/or passive electronic components. These components may include, for example, diodes, transistors, wires, contacts and resistors, as well as switches, sensors (such as light sensors), output devices, input devices, actuators, batteries, LEDs, etc. The device that results from the printed electronics process is referred to as a “printed electronics device” or a “printed electronics circuit”. Thus, the range of applications and possibilities for printed electronics devices is immense.

Naturally, the terms “printed electronics device” and “printed electronics circuit” are not to be confused with the term “printed circuit board” which is a board that supports electrical components (that actually provide the functionality) and connects those components using conductive tracks on the board.

There are a number of benefits of using printed electronics manufacturing technology. One benefit is the ability to produce a complete end-user circuit. This removes a lot of sub-assembly manufacturing steps, thereby reducing costs by a considerable margin, especially for fairly simple electronic circuits with relatively few transistors (or other active components). Similarly, traditional electronics manufacturing technologies require expensive and sophisticated clean room production/fabrication facilities. Additionally, the substrates for printed electronics devices can often be flexible, which is usually not the case for conventional electronics manufacturing. Moreover, printed electronics techniques are generally considered to be more environmentally friendly than conventional electronics manufacturing processes.

More detail on printed electronics techniques and printed electronics devices can be found at, for example, http://en.wikipedia.org/wiki/Printed_electronics (the entire disclosure of which is incorporated herein by reference).

Electrical devices or circuits can also be created using electron-beam lithography (or e-beam lithography). E-beam lithography involves scanning a focused beam of electrons to draw custom shapes on a surface covered with an electron-sensitive film called a resist (a process referred to as “exposing”). The electron beam changes the solubility of the resist, enabling selective removal of either the exposed or non-exposed regions of the resist by immersing the resist in a solvent (a process referred to as “developing”). This enables creation of very small structures in the resist that can subsequently be transferred to the substrate material, often by etching. As e-beam lithography is well-known, further detail shall not be provided herein. However, more information on e-beam lithography can be found at, for example, http://en.wikipedia.org/wiki/Electron-beam_lithography, the entire contents of which are incorporated herein by reference. An example of creation of chips using electron beam lithography is by Mapper Lithography (see http://www.mapperlithography.com/).

Such fabrication techniques enable the efficient production of a series of devices that are each configured differently from the other devices.

### SUMMARY OF THE INVENTION

Current printed electronics manufacturing technologies are ill suited for security applications as the resulting printed electronics devices are vulnerable to hardware attacks (also referred to as “circuit attacks” or “implementation attacks” or “reverse engineering attacks”). Examples of such attacks include simple power analysis, differential power analysis, high-order differential power analysis, side channel attacks, analysis of electromagnetic radiation leaked from the device, timing attacks, etc. (see, for example, http://en.wikipedia.org/wiki/Side-channel_attack, the entire contents of which are incorporated herein by reference). Such traditional hardware attacks involve the attacker using probes, electromagnetic radiation, chemical reactions etc. to try to determine the inner workings or secret information of the hardware device. This is distinct from, for example, software attacks in which an attacker may use a debugger to monitor and modify memory contents, execution flow, etc., which is generally not possible when attacking a hardware device.

Traditional techniques to secure electronic circuits against such hardware attacks are not well suited for protecting printed electronics devices since these silicon hardware protection techniques involve techniques such as adding wire meshes (using multi-layer metal interconnects) or applying hard to remove epoxy layers, with the aim of making it more difficult for an attacker to use probes, electromagnetic radiation, chemical reactions, etc.

The same issues apply to current electronics devices created using e-beam lithography too.

It would, therefore, be desirable to be able to implement security-based functionality with a printed electronics device or an electronics device created by e-beam lithography in a more secure manner, so that even if an attacker were able to launch a hardware attack on the electronics device, there is a reduced likelihood of the attacker been success in his attack (for example, preventing an attacker from accessing secret/sensitive information and/or from causing the device operate in an unauthorised manner).

According to a first aspect of the invention, there is provided an electronics device comprising one or more modules that implement a security-related operation in an obfuscated manner to thereby provide the security-related operation with resistance against a hardware attack, wherein the electronics device is either (a) a printed electronics device or (b) a device created using e-beam lithography.

In some embodiments, the security-related operation uses secret data and wherein the implementation of the security-related operation by the one or more modules protects the secret data against the hardware attack.

In some embodiments, the security-related operation comprises one or more of: (i) a cryptographic operation; (ii) a conditional access operation; (iii) a digital rights management operation; (iv) a key management operation. The cryptographic operation may comprise one or more of: an encryption operation; a decryption operation; a digital signature generation operation; a digital signature verification operation; a hash generation operation; a hash verification operation.

In some embodiments, the security-related operation processes input data in order to generate output data, and the one or more modules implement the security-related operation in an obfuscated manner, at least in part, by being arranged to receive a transformed version of the input data and by being arranged to process the transformed version of the input data to generate a transformed version of the output data.

In some embodiments, the electronics device comprises one or more inputs for receiving input data, and the implementation of the security-related operation by the one or more modules is arranged to use data provided by the one or more inputs. In such embodiments, at least one of the one or more inputs may be arranged to form a transformed version of input data that the at least one of the one or more inputs receives and to provide the transformed version of input data to the one or more modules.

In some embodiments, the electronics device comprises one or more outputs for outputting data, and the implementation of the security-related operation by the one or more modules is arranged to generate processed data and to output provide the processed data to at least one of the one or more outputs. In such embodiments, the processed data may comprise a transformed version of output data and the at least one of the one or more outputs may be arranged to obtain the output data from the transformed version of output data.

In some embodiments, the electronics device comprises one or more sensors, and the implementation of the security-related operation by the one or more modules is arranged to use data generated by the one or more sensors. In such embodiments, at least one of the one or more sensors may be arranged to form a transformed version of input data that the at least one of the one or more sensors generates and to provide the transformed version of input data to the one or more modules.

In some embodiments, the electronics device comprises one or more modules that implement at least one of: (i) an integrity verification operation; (ii) a tamper detection operation; (iii) detection of an attack being performed against the electronics device; (iv) an operation to verify one or more predetermined properties of an object to which the electronics device is connected; (v) an operation to verify that the electronics device is connected to an object.

According to a second aspect of the invention, there is a provided an apparatus comprising any one of the above-mentioned electronics devices.

The apparatus may be an identification label for attachment to an article, wherein: the security-related operation comprises: storing an identification code for identifying the article; and in response to receiving a request, generating a message that comprises the identification code; and the apparatus comprises an interface arranged to: provide the request to the electronics device; receive the message from the electronics device; and output the message. In such an embodiment, the request may comprise a nonce; and the security-related operation may then comprise performing a cryptographic operation based, at least in part, on the nonce and a secret key, wherein the implementation of the security-related operation by the one or more modules protects the secret key against the hardware attack, and wherein the message is based, at least in part, on a result of the cryptographic operation. In such an embodiment, the electronics device may comprise a sensor that is arranged to generate data; and the secret key may be based, at least in part, on the data generated by the sensor. The sensor may be arranged to generate data based on one or more predetermined properties of the article.

In some embodiments, the apparatus is a smartcard.

According to a third aspect of the invention, there is provided a method of generating an electronics device, the electronics device being either (a) a printed electronics device or (b) a device created using e-beam lithography, the method comprising: including, as part of the electronics device, one or more modules that implement a security-related operation in an obfuscated manner to thereby provide the security-related operation with resistance against a hardware attack.

In some embodiments, the method comprises: receiving code, written in a hardware description language, wherein the code represents functionality for the electronics device including the security-related operation; applying one or more white-box protection techniques to the received code to form protected code that protects the security-related operation against the hardware attack; and using the protected code to generate the electronics device. Using the protected code may comprise converting the protected code into a netlist for the electronics device and creating the electronics device based on the netlist.

In some embodiments of the third aspect of the invention, the electronics device is an electronics device according to the first aspect of the invention (or any one of its embodiments).

According to a fourth aspect of the invention, there is provided an apparatus arranged to carry out a method according to any one of the above-mentioned methods.

According to a fifth aspect of the invention, there is provided a computer program which, when executed by a processor, causes the processor to carry out any one of the above-mentioned methods. The computer program may be stored on a computer-readable medium.

### BRIEF DESCRIPTION OF THE DRAWINGS

Embodiments of the invention will now be described, by way of example only, with reference to the accompanying drawings, in which:

FIG. 1 schematically illustrates a system according to an embodiment of the invention;

FIG. 2 schematically illustrates an example of a computer system;

FIG. 3 is a flowchart illustrating a method for operating the system of FIG. 1 according to an embodiment of the invention;

FIG. 4a schematically illustrates an example printed electronics device;

FIG. 4b schematically illustrates an example printed electronics device according to an embodiment of the invention;

FIG. 4c schematically illustrates another example printed electronics device according to an embodiment of the invention;

FIG. 5 schematically illustrates an example function to be obfuscated using embodiments of the invention;

FIGS. 6a and 6b schematically illustrate how to implement a lookup table using logic expressions;

FIGS. 7a and 7b schematically illustrate example processing for the security-related function of a printed electronics device according to an embodiment of the invention;

FIG. 8 schematically illustrates another embodiment of the invention;

FIG. 9 schematically illustrates an example of a computer system including an optimization and protection toolset A40;

FIG. 10 illustrates in more detail an example of the optimization and protection toolset A40 of FIG. 9;

FIG. 11 provides a flow diagram of a method example;

FIG. 12 illustrates a work flow which can be implemented by the optimization and protection toolset A40 of FIG. 10;

FIG. 13 illustrates a work flow similar to that of FIG. 12 but within which an input item of software in a source code representation is converted to LLVM IR using LLVM front end tools;

FIG. 14 is similar to FIG. 13 but with an input item of software in a binary or native code representation;

FIG. 15 illustrates a work flow similar to that of FIGS. 12 to 14 but within which LLVM compiler middle layer tools are used to implement binary rewriting protection of the item of software in the first intermediate representation;

FIG. 16 shows a work flow which may be implemented using the optimization and protection toolset of FIG. 10, in which the output representation is an asm.js or other executable script representation;

FIG. 17 shows schematically the optimization and protection toolset of FIG. 10 with some further variations and details;

FIG. 18 shows how the arrangement of FIG. 10 can be expanded to use a larger number of intermediate representations, and to apply optimization and/or protection in different ones of these intermediate representations; and

FIG. 19 illustrates the processing of software items such as security libraries, modules and agents by the optimization and protection toolset.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1—System Overview

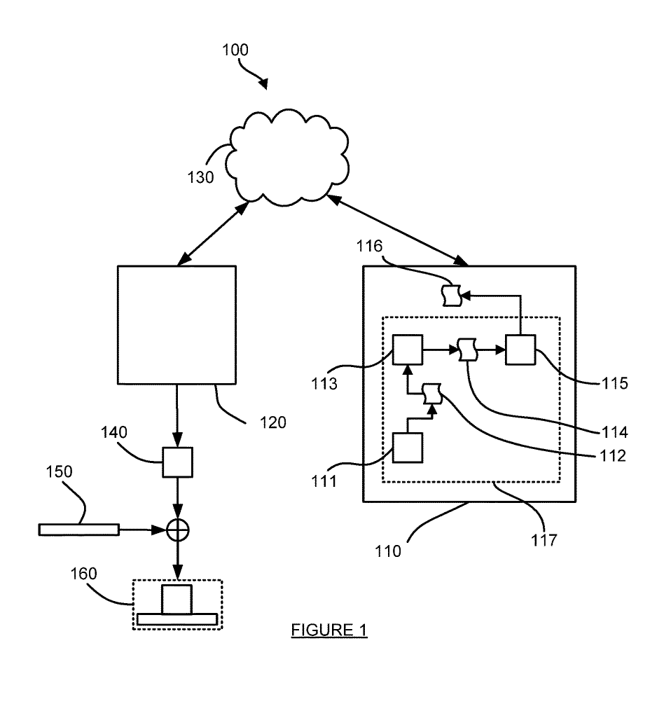

FIG. 1 schematically illustrates a system 100 according to an embodiment of the invention. The system 100 comprises a computer system 110, a printer 120 and a network 130.

The network 130 may be any kind of data communication network suitable for communicating or transferring data between the computer system 110 and the printer 120. Thus, the network 130 may comprise one or more of: a local area network, a wide area network, a metropolitan area network, the Internet, a wireless communication network, a wired or cable communication network, a satellite communications network, a telephone network, etc. The computer system 110 and the printer 120 may be arranged to communicate with each other via the network 130 via any suitable data communication protocol. It will, of course, be appreciated that there may be one or more intermediary computers or devices between the computer system 110 and the printer 120 that enable communication of data between the computer system 110 and the printer 120—these are shown, generally, as part of the network 130.

The printer 120 may be any printing device that can generate a printed electronics device 140 via a printing technology. As described above, there are many different possible functionalities or uses or configurations for the printed electronics device 140, and there are numerous possible printing technologies or techniques (currently available and yet to be developed) that can be used to generate or form the printed electronics device 140. Therefore, the printer 120 may be any printing device that implements one or more of such printing technologies to generate printed electronics devices 140. As such printers 120 are well-known, and as such printing technologies are well-known, they shall not be described in more detail herein.

As described above, the printer 120 is connected, or is in communication with, the network 130. Thus, the printer 120 is arranged to receive data via the network 130, where this data defines a printed electronics device 140 to be printed by the printer 120. In other words, the printer 120 is arranged to receive data via the network 130, and to process the received data, where the received data causes the printer 120 to print (and thereby form or generate) the printed electronics device 140. The data may comprise configuration data for the printer 120 and/or details of the actual printed electronics device 140 that is to be printed and output by the printer 120 and/or one or more commands (such as a “print” command for the printer 120). The printing itself may be a wholly automatic process. Alternatively, the printer 120 may require some manual input from an operator of the printer 120. Again, this is well-known and shall not, therefore, be described in more detail herein.

As shown in FIG. 1, the printed electronics device 140 generated by the printer 120 may be combined with (or attached to or coupled with) another item 150 (or article or object) to form a new item 160 (or article or object). This may simply involve adhering the printed electronics device 140 to the item 150 (with an adhesive or bonding agent). The item 150 may, itself, have one or more electronic components (e.g. one or more sensors or inputs or outputs or interfaces), and the printed electronics device 140 may, therefore, be combined with the item 150 so that one or more of the electronic components of the item 150 and the printed electronics device 140 may interact (e.g. a sensor and/or an input of the item 150 may provide data to the printed electronics device 140; the printed electronics device 140 may provide data to an output of the item 150; etc.). Examples of this shall be described in more detail later.

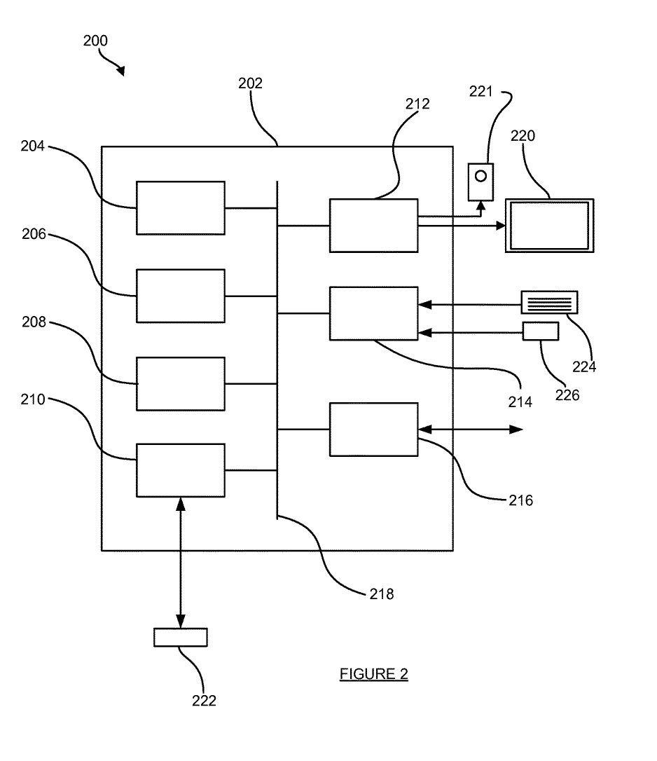

The computer system 110 may be any computer system, such as one or more of the exemplary computer systems 200 shown in FIG. 2 (to be described shortly). For example, the computer system 110 may comprise one or more of a personal computer, a server computer, a tablet, a laptop, etc.

The computer system 110 is arranged to generate a data file 116 (which may, in practice, comprise one or more files) for sending to the printer 120 via the network 130. The data file 116 comprises data that, as described above, causes the printer 120 to print the printed electronics device 140. The data file 116 may be in any format suitable for use by the printer 120. The computer system 110 comprises a tool 117 for generating the data file 116. The tool 117 may, therefore, comprise one or more software applications, executing on one or more processors of the computer system 117.

In the example embodiment shown in FIG. 1, the tool 117 comprises: a design module 111; a protection module 113 and an output module 115. One or more of the design module 111, protection module 113 and output module 115 may, in practice, be implemented as a separate, stand-alone, application, so that dashed line in FIG. 1 showing the design module 111, protection module 113 and output module 115 as being part of a single tool 117 is purely to illustrate these stand-alone applications being part of a larger suite of applications that together form the tool 117. In other embodiments, however, the design module 111, protection module 113 and output module 115 may form part of a single software application (namely the tool 117) so that the dashed line in FIG. 1 represents an actual application executing on the computer system 110.

The design module 111 may be any convention module for designing a printed electronics device 140. For example, the design module 111 may enable one or more designers to design some or all of the printed electronics device 140, or write or design some or all of the functionality for the printed electronics device 140, using a hardware description language (HDL). As is well-known, an HDL is a computer program language that may be used to program the structure, design and operation of electronic circuits. The HDL may, for example, be VHDL or Verilog, although it will be appreciated that many other HDLs exist and could be used in embodiments of the invention instead. As HDLs (and their uses and implementations) are well-known, they shall not be described in more detail herein, however, more detail can be found, for example, at http://en.wikipedia.org/wiki/Hardware_description_language, the entire disclosure of which is incorporated herein by reference.

The design module 111 may, therefore, be used to generate a design file 112 (which may, in practice, comprise one or more files) that contains data specifying some or all of the desired functionality (i.e. operations, functions, processing, procedures, data flows, etc.) for the printed electronics device 140. For example, the design file 112 may comprise code written in an HDL.

Additionally, or alternatively, the tool 117 may be arranged to receive a design file 112 from another system or application of the computer system 110 (for example, a previously created design file 112 may already be being stored by the computer system 110), or from a different computer system (not shown in FIG. 1) via the network 130. Thus, the presence of the design module 111 as part of the tool 117 is optional.

The protection module 113 is arranged to receive the design file 112 and to apply one or more protection techniques to the design file 112 to thereby generate a protected design file 114 (which may, in practice, comprise one or more files). The protected design file 114, like the design file 112, contains data specifying functionality for the printed electronics device 140 (i.e. operations, functions, processing, procedures, data flows, etc.)—however, by applying the one or more protection techniques to the design file 112: (a) some or all of the functionality is implemented, or specified, in the protected design file 114 in a manner that has resistance or robustness against one or more “white-box attacks” (so that protection is provided against an attacker in possession of the protected design file 114) and (b) the resulting printed electronics device 140 has increase robustness or resistance against hardware attacks. White-box attacks and the protection techniques shall be described later.

The protected design file 114 may comprise code written in an HDL (such as the same HDL as used for the design file 112). However, this need not necessarily be the case. For example, the protection module 113 may perform additional processing (such as a compilation or synthesis step) to yield a compiled or synthesised protected design file 114.

The output module 115 is an optional module of the tool 117 (and may, therefore, be omitted in some embodiments of the invention). The output module 115 performs one or more processing steps that are needed to convert the protected design file 114 from the format output by the protection tool 113 to the format of the data file 116 that the printer 120 requires as its input. For example, if the protected design file 114 is written in an HDL, the format of the data file 116 may be a netlist, in which case the output module 115 may perform compilation and/or synthesis processing in order to generate a netlist to be in included in the data file 116. Additionally, or alternatively, the printer 120 may require the data file 116 to be in a specific format, in which case the output module 115 may be arranged to perform a format conversion operation from the format of the protected design file 114 to that specific format. Additionally, or alternatively, the functionality defined by the protected design file 114 may be only a subset of the entire functionality for the printed electronics device 140, in which case the output module 115 may be arranged to receive one or more other files (for example with additional HDL code) and to combine the one or more other files with the protected design file 114 to generate a final/complete design for the printed electronics device 140. It will be appreciated that the output module 115 may, additionally or alternatively, carry out other operations accordingly to generate the data file 116.

In some embodiments, the printer 120 may be part of, or directly coupled to, the computer system 110, in which case the network 130 may be omitted from the system 100.

The system 100 of FIG. 1 has been described above in relation to generating printed electronics devices 140. However, it will be appreciated that, instead of using printed electronics technologies, the system 100 could use e-beam lithography to create an electronics device 140 (so that the device 140 is no longer a printed electronics device 140 but is, instead a device created using e-beam lithography). In this case, the printer 120 is replaced by a device that creates devices using e-beam lithography. Thus, the data file 116 (which may, in practice, comprise one or more files) comprises data that, as described above, causes the device to generate the device 140 using e-beam lithography. The data file 116 may be in any format suitable for use by the device 120. Thus, whilst embodiments of the invention are described herein by referring to “printed electronics devices 140” created by the “printer 120” “printing” those devices, it will be appreciated that other embodiments of the invention may make use of e-beam lithography instead of printed electronics technology. Thus, whilst embodiments of the invention are set out herein based on printed electronics technology, it will be appreciated that the description herein of embodiments of the invention applies equally to these other “e-beam” embodiments, and it will be appreciated that, when in relation to these other “e-beam” embodiments (i) references herein to a “printed electronics device 140” would be replaced by a “device 140 created using e-beam lithography”; (ii) references herein to the “printer 120” would be replaced by an “apparatus/system for creating a device 140 using e-beam lithography”; (iii) references to “printing” would be replaced by “forming a device 140 using e-beam lithography”; (iv) other aspects of printed electronics technology would be replaced by their respective counterpart in e-beam lithography.

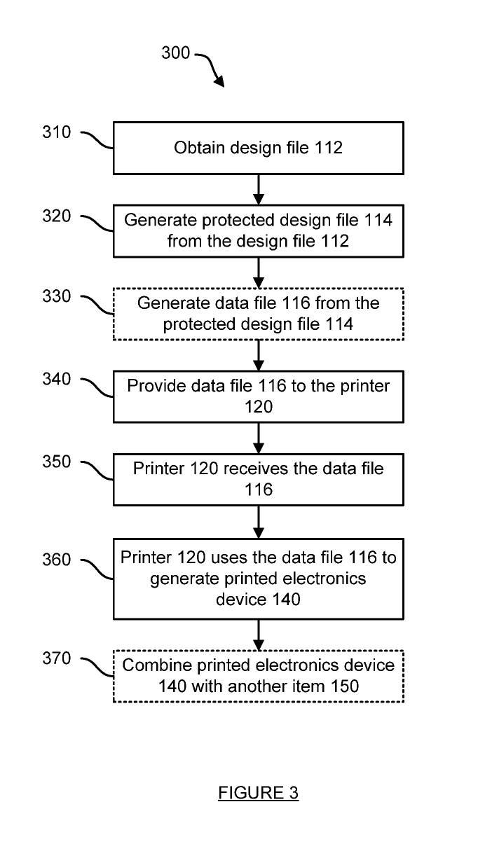

FIG. 3 is a flowchart illustrating a method 300 for operating the system 100 of FIG. 1 according to an embodiment of the invention.

At a step 310, the computer system 110 obtains the design file 112. As mentioned above, this may involve one or more designers using the design tool 111 to actually create the design file 112. Alternatively, this may involve the computer system 110 receiving or obtaining an existing design file 112 (e.g. from local storage on the computer system 110 and/or from a separate computer system via the network 130).

At a step 320, the computer system 110 uses the protection module 113 to process the design file 112 to generate a protected design file 114.

At an optional step 330, the computer system 110 uses the output module 115 to process the protected design file 114 to generate a data file 116 that is suitable for provision to the printer 120. If the output module 115 is not used in this manner, then the data file 116 is, in effect, the same as the protected design file 114.

At a step 340, the computer system 110 provides the data file 116 to the printer 120, for example via the network 130.

At a step 350, the printer 120 receives the data file 116 from the computer system 110.

At a step 360, the printer 120 uses the received data file 116 to print, and therefore generate, the printed electronics device 140.

At an optional step 370, the printed electronics device 140 is combined with an item 150 to thereby generate a new item 160.

FIG. 2 schematically illustrates an example of a computer system 200. The system 200 comprises a computer 202. The computer 202 comprises: a storage medium 204, a memory 206, a processor 208, an interface 210, a user output interface 212, a user input interface 214 and a network interface 216, which are all linked together over one or more communication buses 218.

The storage medium 204 may be any form of non-volatile data storage device such as one or more of a hard disk drive, a magnetic disc, an optical disc, a ROM, etc. The storage medium 204 may store an operating system for the processor 208 to execute in order for the computer 202 to function. The storage medium 204 may also store one or more computer programs (or software or instructions or code).

The memory 206 may be any random access memory (storage unit or volatile storage medium) suitable for storing data and/or computer programs (or software or instructions or code).

The processor 208 may be any data processing unit suitable for executing one or more computer programs (such as those stored on the storage medium 204 and/or in the memory 206), some of which may be computer programs according to embodiments of the invention or computer programs that, when executed by the processor 208, cause the processor 208 to carry out a method according to an embodiment of the invention and configure the system 200 to be a system according to an embodiment of the invention. The processor 208 may comprise a single data processing unit or multiple data processing units operating in parallel or in cooperation with each other. The processor 208, in carrying out data processing operations for embodiments of the invention, may store data to and/or read data from the storage medium 204 and/or the memory 206.

The interface 210 may be any unit for providing an interface to a device 222 external to, or removable from, the computer 202. The device 222 may be a data storage device, for example, one or more of an optical disc, a magnetic disc, a solid-state-storage device, etc. The device 222 may have processing capabilities—for example, the device may be a smart card. The interface 210 may therefore access data from, or provide data to, or interface with, the device 222 in accordance with one or more commands that it receives from the processor 208.

The user input interface 214 is arranged to receive input from a user, or operator, of the system 200. The user may provide this input via one or more input devices of the system 200, such as a mouse (or other pointing device) 226 and/or a keyboard 224, that are connected to, or in communication with, the user input interface 214. However, it will be appreciated that the user may provide input to the computer 202 via one or more additional or alternative input devices (such as a touch screen). The computer 202 may store the input received from the input devices via the user input interface 214 in the memory 206 for the processor 208 to subsequently access and process, or may pass it straight to the processor 208, so that the processor 208 can respond to the user input accordingly.

The user output interface 212 is arranged to provide a graphical/visual and/or audio output to a user, or operator, of the system 200. As such, the processor 208 may be arranged to instruct the user output interface 212 to form an image/video signal representing a desired graphical output, and to provide this signal to a monitor (or screen or display unit) 220 of the system 200 that is connected to the user output interface 212. Additionally or alternatively, the processor 208 may be arranged to instruct the user output interface 212 to form an audio signal representing a desired audio output, and to provide this signal to one or more speakers 221 of the system 200 that is connected to the user output interface 212.

Finally, the network interface 216 provides functionality for the computer 202 to download data from and/or upload data to one or more data communication networks.

It will be appreciated that the architecture of the system 200 illustrated in FIG. 2 and described above is merely exemplary and that other computer systems 200 with different architectures (for example with fewer components than shown in FIG. 2 or with additional and/or alternative components than shown in FIG. 2) may be used in embodiments of the invention. As examples, the computer system 200 could comprise one or more of: a personal computer; a server computer; a tablet; a laptop; etc. As mentioned above, the computer system 100 of FIG. 1 may comprise one or more of the computer systems 200 of FIG. 2.

### 2—Securing or Protecting the Printed Electronics Device

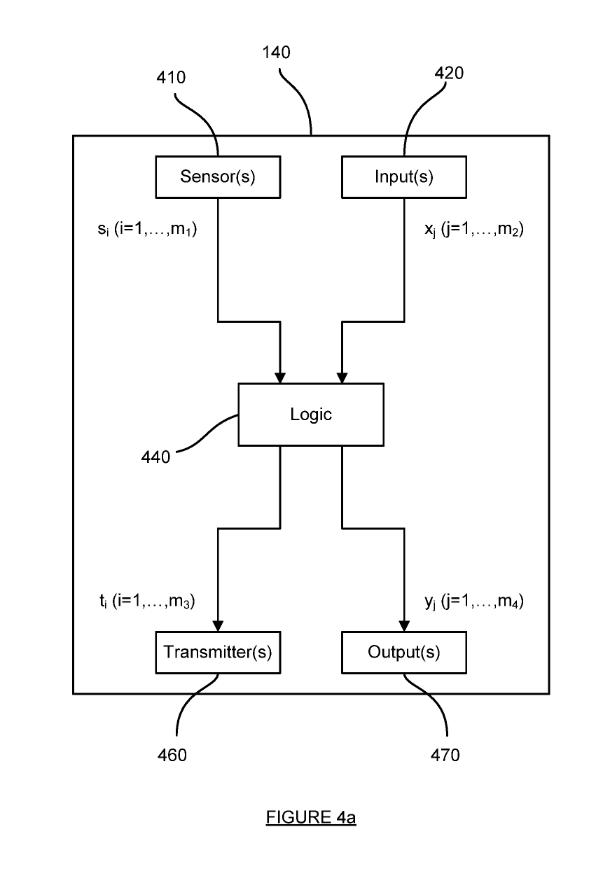

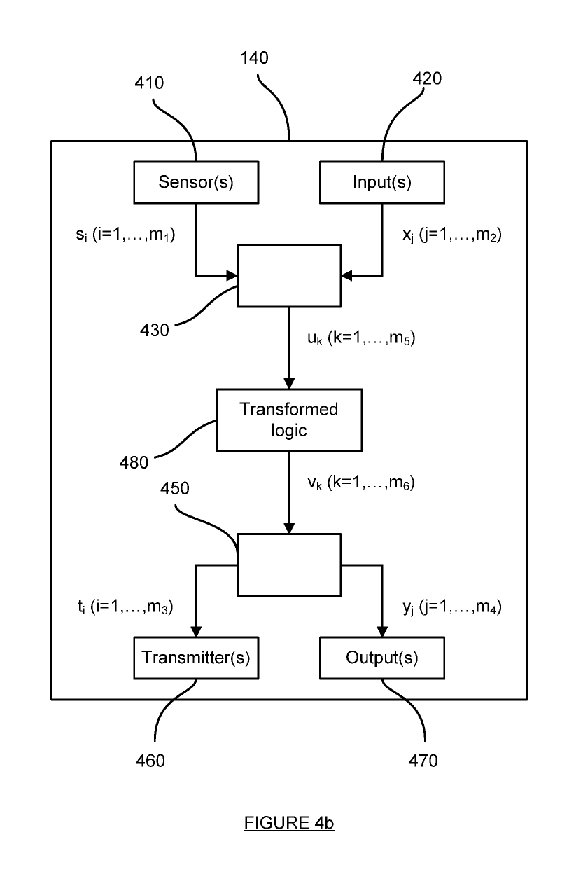

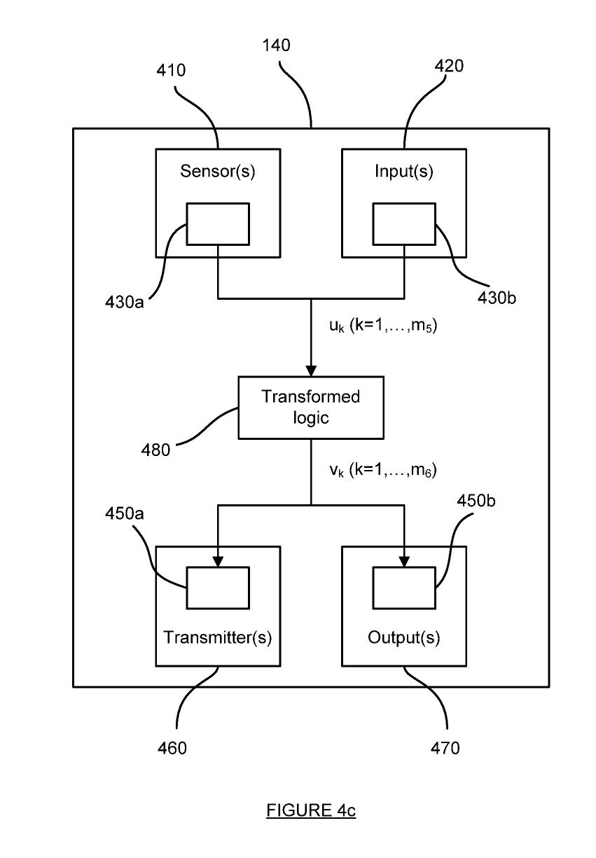

FIG. 4a schematically illustrates an example printed electronics device 140 that the printer 120 may generate if the design file 112 were provided to the output module 115 directly (instead of the design file 112 being passed to the protection module 113 so that the protection module 113 may then process the design file to produce a protected design file 114 that is provided to the output module 115).

The printed electronics device 140 comprises logic 440 that implements the desired functionality (i.e. operations, functions, processing, procedures, data flows, etc.).

In some embodiments, the printed electronics device 140 comprises one more sensors 410 (such as light sensors or temperature sensors)—the one or more sensors 410 may provide data values sᵢ to the logic 440 to be processed by the logic. As shown in FIG. 4a, if the printed electronics device 140 comprises the one more sensors 410 then there are m₁ data values sᵢ (i=1, . . . , m₁, m₁≧1) provided by the one or more sensors 410 to the logic 440.

In some embodiments, the printed electronics device 140 comprises one more inputs 420 (such as an input for receiving a data value from another entity, such as the item 150, or an input may be a wireless data communication input for receiving data via a wireless data communication path)—the one or more inputs 420 may provide data values xⱼ to the logic 440 to be processed by the logic. As shown in FIG. 4a, if the printed electronics device 140 comprises the one more inputs 420 then there are m₂ data values xⱼ (j=1, . . . , m₂, m₂≧1) provided by the one or more inputs 420 to the logic 440.

The output, or result, of the processing performed by the logic 440 may comprise one or more data values.

In some embodiments, the printed electronics device 140 comprises one more transmitters 460 (such as a wireless data transmitter) and the output or result of the processing performed by the logic 440 comprises one or more data values tᵢ to be provided to the one or more transmitters 460. As shown in FIG. 4a, if the printed electronics device 140 comprises the one more transmitters 460 then there are m₃ data values tᵢ (i=1, . . . , m₃, m₃≧1) output by the logic 440.

In some embodiments, the printed electronics device 140 comprises one more outputs 470 (such as a data connection to the item 150 or an output comprising an LED) and the output or result of the processing performed by the logic 440 comprises one or more data values yⱼ to be provided to the one or more outputs 470. As shown in FIG. 4a, if the printed electronics device 140 comprises the one more outputs 470 then there are m₄ data values yⱼ (j=1, . . . , m₄, m₄≧1) output by the logic 440.

In embodiments of the invention, the design file 112 is written so that the logic 440 (or the printed electronic device 140) comprises one or more modules that implements a security-related operation (potentially in addition to one or more other operations). Herein, a “module” of the printed electronics device 140 (or of the logic 440) comprises a collection of one or more hardware components (such as gates, transistors, registers and other electronic components) that provide particular functionality—thus, the one or more modules comprise one or more collections of such hardware components that, together, implement the security-related operation. For example, the security-related operation may use secret data (such as a cryptographic key)—the secret data may be stored by the logic 440, or the logic 440 may be arranged to implement the cryptographic key. The security-related operation may comprise one or more of (i) a cryptographic operation (such as one or more: of an encryption operation; a decryption operation; a digital signature generation operation; a digital signature verification operation; a hash generation operation; a hash verification operation); (ii) a conditional access operation; (iii) a digital rights management operation; (iv) a (cryptographic) key management operation. Such security-related operations are well-known and shall, therefore, not be described in more detail herein. In general, though, the security-related operation is an operation for which (a) it is desirable to prevent an attacker from accessing some or all of the data being used for performing the security-related operation (e.g. the secret data) and/or (b) it is desirable to prevent an attacker from modifying or changing the functioning or processing of the security-related operation to thereby make the security-related operation perform in an unauthorized manner or provide a result that the attacker is not entitled to achieve.

The security-related operation may process one or more of the data values sᵢ (i=1, . . . , m₁) and/or xⱼ (j=1, . . . , m₂) to generate output data which may, for example, comprise one or more of the data values tᵢ (i=1, . . . , m₃) and/or yⱼ (j=1, . . . , m₄)

A “white-box” environment is an execution environment for software data processing in which an attacker of the data processing is assumed to have full access to, and visibility of, the data being operated on (including intermediate values), memory contents and execution/process flow of the software data processing. Moreover, in the white-box environment, the attacker is assumed to be able to modify the data being operated on, the memory contents and the execution/process flow of the software data processing—in this way, the attacker can experiment on, and try to manipulate the operation of, the data processing, with the aim of circumventing initially intended functionality and/or identifying secret information and/or for other purposes. Indeed, one may even assume that the attacker is aware of the underlying algorithm being performed by the data processing. However, the data processing may need to use secret information (e.g. one or more cryptographic keys), where this information needs to remain hidden from the attacker. Similarly, it would be desirable to prevent the attacker from modifying the execution/control flow of the data processing, for example preventing the attacker forcing the data processing to take one execution path after a decision block instead of a legitimate execution path. A “white-box” attack is an attack that an attacker may perform on software data processing (for example to try to ascertain secret information or to modifying the execution/control flow of the data processing so as to achieve a desired goal/aim) when the data processing is performed in a white-box environment. White-box attacks are well-known. White-box attacks are attacks performed on items of software (or code or instructions), as the attacker can execute (or run or emulate) such items of software in a software environment (such as a debugger) which enables the attacker to monitor and modify data values in memory and/or control flow during execution—for this reason, white-box attacks are not considered applicable to hardware devices.

The data file 116, when provided from the computer system 110 to the printer 120, could be intercepted by an attacker, who may then be able to analyse the data file 116 and potentially run it or use it in a simulator/emulator—thus, the data file 116 may be considered to be open to white-box attacks. Even if the data file 116 is transmitted to the printer 120 in encrypted form, the printer 120 will need to decrypt the data file 116 in order to carry out the printing process to generate the printed electronics device 140—at this point, an attacker may be able to perform white-box attacks. Similarly, an attacker may be in possession of a printed electronics device 140 generated by the printer. As mentioned above, traditional techniques to secure electronics circuits against hardware attacks (as opposed to software white-box attacks) are not well suited for protecting printed electronic devices 140 and, therefore, an attacker may be able to more easily perform hardware attacks against the printed electronics device 140 itself.

The purpose of the protection module 113 is, therefore, to generate the protected design file 114 based on the initial design file 112. The protection module 113 generates the protected design file 114 so that the printed electronics device 140 comprises one or more modules that implement the security-related operation in an obfuscated manner to thereby provide the security-related operation with resistance against a hardware attack. Examples of how this can be performed shall be described in more detail below. In particular, though, it has been inventively realized that, whilst white-box protection techniques have traditionally be used to protect items of software (since items of software are open to white-box attacks, whereas white-box attacks are not appropriate to hardware devices), and that whilst traditional electronics devices have used other protection techniques to counter hardware attacks (such as adding wire meshes using multi-layer metal interconnects or applying hard to remove epoxy layers), printed electronics devices that are more open to hardware attacks can be secured by applying white-box techniques to the functionality that they implement, to thereby make it more difficult, when an attacker is performing a hardware attack on the printed electronics device, to understand the functionality being implemented or the data being used.

In some embodiments, one or more bijective functions (or transformations or transforms) will be used. A bijective function is a function that is injective (i.e. is a 1-to-1 mapping) and that is subjective (i.e. maps onto the whole of a particular range of values). If the domain of possible input values for the function T is domain Dom, and if the function T is an injective function (so that T(a)=T(b) if and only if a=b), then T is a bijective function from Dom onto the range T(Dom)={T(a): aεDom}.

An initial simple example will help understand how the use of bijective functions T can help provide protection against attacks. In this example, the bijective functions T are linear transformations in a Galois field GF(ψⁿ) for some prime number ψ and positive integer n, i.e. T: GF(ψⁿ)→GF(ψⁿ). For example, if data values sᵢ (i=1, . . . , m₁) and xⱼ (j=1, . . . , m₂) are Z-bit data values, then they may be viewed as elements of the Galois field GF(2^{Z}), so that ψ=2 and n=Z.

Consider a predetermined function G that operates on elements s₁ and s₂ (although, of course, other data values sᵢ or xⱼ could be used) in the Galois field GF(ψⁿ) according to r=G(s₁,s₂)=s₁+s₂, where + is addition in the Galois field GF(ψⁿ). In this Galois field GF(ψⁿ), the addition s₁+s₂ is the same as an XOR operation, so that r=G(s₁,s₂)=s₁⊕s₂. Let s₁*, s₂* and r* be transformed versions of s₁, s₂ and r according to respective linear transformations T₁, T₂ and T₃ in the Galois field GF(ψⁿ), so that s₁*=T₁(s₁)=a·s₁+b, s₂*=T₂(s₂)=c·s₂+d and r*=T₃(r)=e·r+f for arbitrary non-zero constants a, c, and e in the Galois field GF(ψⁿ), and arbitrary constants b, d and fin the Galois field GF(ψⁿ) (so that constants a, c, and e may be randomly chosen from GF(ψⁿ)/{0} and constants b, d, and f may be randomly chosen from GF(ψⁿ)). Then

r*=e·(s₁+s₂)+f=e·(a⁻¹(s₁*+b)+c⁻¹(s₂*+d))+f=g·s₁*+h·s₂*+i, where g=e·a⁻¹,h=e·c⁻¹ and i=e·(a⁻¹b+c⁻¹d)+f.

Thus, given the transformed versions s₁*=T₁(s₁*) and s₂*=T₂(s₂) of the inputs s₁ and s₂, it is possible to calculate the transformed version r*=T₃(r) of the result r without having to remove any of the transformations (i.e. without having to derive s₁ and/or s₂ from the versions s₁* and s₂*). In particular, having defined the transformations T₁, T₂ and T₃ by their respective parameters (a and b for T₁, c and d for T₂, e and f for T₃), a transformed version G* of the function G can be implemented according to G*(s₁*,s₂*)=g·s₁*+h·s₂*+i, where g=e·a⁻¹, h=e·c⁻¹ and i=e·(a⁻¹b+c⁻¹d)+f, so that r*=G*(s₁*,s₂*) can be calculated without determining/revealing s₁ or s₂ as an intermediate step in the processing. The result r can then be obtained from the transformed version r*=G*(s₁*,s₂*) of the result r, as r=e⁻¹(r*+f))—thus, a linear transformation T₄ (which is the inverse of T₃) can be used to obtain the result r from the transformed version r*, where r=T₄(r*)=e⁻¹r*+e⁻¹f. Alternatively, the transformed version r* of the result r could be an input to a subsequent function. In other words, given the function G that operates on inputs s₁ and s₂ to produce a result r, if transformations T₁, T₂ and T₃ are specified (e.g. randomly, by choosing the parameters for the transformations randomly, or based on some other parameters/data), then a transformed version G* of the function G can be generated/implemented, where the function G* operates on transformed inputs s₁*=T₁(s₁*) and s₂*=T₂(s₂) to produce a transformed result r*=T₃(r) according to r*=g·s₁*+h·s₂*+i. If a person implements the function G* in a white-box environment, then that person cannot identify what operation the underlying function G is performing, nor can the person determine the actual result r nor in inputs s₁ and s₂ (since these values are never revealed when performing the function G*).

As another example, supposes that the function G operates on element s₁ (although, of course, other data values s₁ or xⱼ could be used) in the Galois field GF(ψⁿ) according to r=G(s₁*)=s₁*+k, where + is addition in the Galois field GF(ψⁿ) and k is a predetermined secret value (such as a cryptographic key). In this Galois field GF(ψⁿ), the addition s₁*+k is the same as an XOR operation, so that r=G(s₁*)=s₁*⊕k. Let s₁* and r* be transformed versions of s₁ and r according to respective linear transformations T₁ and T₃ in the Galois field GF(ψⁿ), so that s₁*=T₁(s₁*)=a·s₁*+b and r*=T₃(r)=e·r+f for arbitrary non-zero constants a and e in the Galois field GF(ψⁿ), and arbitrary constants b and fin the Galois field GF(ψⁿ) (so that constants a and e may be randomly chosen from GF(V)/{0} and constants b and f may be randomly chosen from GF(ψⁿ)). Then r*=e·(s₁*+k)+f=e·(a⁻¹(s₁*+b)+k)+f=g·s₁*+h, where g=e·a⁻¹ and h=e·(a⁻¹b+k)+f.

Thus, given the transformed version s₁*=T₁(s₁*) of the input s₁*, it is possible to calculate the transformed version r*=T₃(r) of the result r without having to remove any of the transformations (i.e. without having to derive s₁ from the version s₁*). In particular, having defined the transformations T₁ and T₃ by their respective parameters (a and b for T₁, e and f for T₃), a transformed version G* of the function G can be implemented according to G*(s₁*)=g·s₁*+h, where g=e·a⁻¹, h=e·(a⁻¹b+k)+f, so that r*=G*(s₁*) can be calculated without determining/revealing s₁ and without the secret value k being available to an attacker. The result r can then be obtained from the transformed version r*=G*(s₁*,s₂*) of the result r, as r=e⁻¹(r*+f))—thus, a linear transformation T₄ (which is the inverse of T₃) can be used to obtain the result r from the transformed version r*, where r=T₄(r*)=e⁻¹r*+e⁻¹f. Alternatively, the transformed version r* of the result r could be an input to a subsequent function. In other words, given the function G that operates on inputs s₁ to produce a result r, if transformations T₁ and T₃ are specified (e.g. randomly, by choosing the parameters for the transformations randomly, or based on some other parameters/data), then a transformed version G* of the function G can be generated/implemented, where the function G* operates on the transformed input s₁*=T₁(s₁*) to produce a transformed result r*=T₃(r) according to r*=g·s₁*+h. If a person implements the function G* in a white-box environment, then that person cannot identify what operation the underlying function G is performing, nor can the person determine the actual result r nor the input s₁ nor the secret key k (since these values are never revealed when performing the function G*).

Note that in the above examples, it is possible for one or both of T₁ and T₂ to be the identity transformation (i.e. T₁ is the identity transformation if T₁(s₁)=s₁ for all values of s₁*, so that a=1 and b=0 in the above example, and T₂ is the identity transformation if T₂(s₂)=s₂, so that c=1 and d=0 in the above example). If this is the case, then the person implementing the function G* can identify the value assumed by the input sᵢ (if T₁ is the identity transformation) and/or the value assumed by the input s₂ (if T₂ is the identity transformation). However, so long as T₃ is not the identity transformation, then that person cannot identify what operation the underlying function G is performing, nor can the person determine the actual result r.

Similarly, in the above examples, it is possible for T₃ to be the identity transformation (i.e. T₃ is the identity transformation if T₃(r)=r for all values of r, so that e=1 and f=0 in the above example). If this is the case, then the person implementing the function G* can identify the value assumed by the output r. However, so long as one or both of T₁ and T₂ are not the identity transformation, then that person cannot identify what operation the underlying function G is performing, nor can the person determine one or both of the initial inputs s₁ and s₂.

It will be appreciated that other functions G could be implemented as a corresponding “transformed version” G*, where the input(s) to the function G* are transformed versions of the input(s) to the function G according to respective injective (1-to-1) transformations and the output(s) of the function G* are transformed versions of the output(s) of the function G according to respective injective transformations. The transformations need not necessarily be linear transformations as set out above, but could be any other kind of injective transformation. Thus, given a function G that has u inputs α₁, . . . , αᵤ and v outputs β₁, . . . βᵥ, a transformed version G* of the function G can be implemented, where G* has transformed versions α₁*, . . . , α*ᵤ of the inputs α₁, . . . , αᵤ as its input and outputs transformed versions β₁*, . . . , βᵥ* of the outputs β₁, . . . , βᵥ, where α₁*=Tᵢ(αᵢ) and βᵢ*=Tᵢ₊ᵤ(βᵢ) for injective functions T₁, . . . Tᵤ₊ᵥ. It is possible that two or more of the functions Tᵢ might be the same as each other. The fact that this can be done for any function G is discussed below.

As set out below, the XOR operation, along with conditional branching on constants, forms a system which is Turing complete. This means that any mathematical function can be implemented using only (a) zero or more XOR operations and (b) zero or more conditional branchings on constants.

A Turing machine is a notional device that manipulates symbols on a strip of tape according to a table of rules. Despite its simplicity, a Turing machine can be adapted to simulate the logic of any computer algorithm. The Turing machine mathematically models a machine that mechanically operates on a tape. On this tape are symbols which the machine can read and write, one at a time, using a tape head. Operation is fully determined by a finite set of elementary instructions such as “in state 42, if the symbol seen is 0, write a 1; if the symbol seen is 1, change into state 17; in state 17, if the symbol seen is 0, write a 1 and change to state 6” etc. More precisely, a Turing machine consists of:
1. A tape which is divided into cells, one next to the other. Each cell contains a symbol from some finite alphabet. The alphabet contains a special blank symbol (here written as ‘B’) and one or more other symbols. The tape is assumed to be arbitrarily extendable to the left and to the right, i.e. the Turing machine is always supplied with as much tape as it needs for its computation. Cells that have not been written to before are assumed to be filled with the blank symbol.
2. A head that can read and write symbols on the tape and move the tape left and right one (and only one) cell at a time.
3. A state register that stores the current state of the Turing machine, one of finitely many states. There is one special start state with which the state register is initialized.
4. A finite table (occasionally called an action table or transition function) of one or more instructions (each usually expressed as a respective quintuple Sᵢaⱼ→Sᵢ₁aⱼ₁dₖ) that specifies that: if the Turing machine is currently in the state Sᵢ and has currently read the symbol aⱼ from the tape (i.e. the symbol currently under the head is aⱼ), then the Turing machine should carry out the following sequence of operations:
   Write aⱼ₁ in place of the current symbol aⱼ. (Symbol aⱼ₁ could be the blank symbol).
   Control the position of the head, as described by dₖ. dₖ can have values: ‘L’ to indicate moving the head one cell left, ‘R’ to indicate moving the head one cell right; or ‘N’ to indicate not moving the head, i.e. staying in the same place.
   Set the current state to be the state specified by Sᵢ₁ (which may be the same as, or different from, Sᵢ).

Turing machines are very well-known and shall, therefore, not be described in more detail herein.

If it can be shown that any possible 5-tuple in the action table can be implemented using the XOR operation and conditional branching on constants, then we know that a processing system based on the XOR operation and conditional branching on constants is Turing complete (since any function or computer program can be implemented or modelled as a Turing machine, and all of the 5-tuples in the action table of that Turing machine can be implemented using the XOR operation and conditional branching on constants).

Consider the following mappings between the elements in the Turing machine and those in a system that uses only XORs and conditional branching on constants:
(a) The alphabet size of the Turing machine is set to the size ψⁿ of the alphabet GF(ψⁿ).
(b) Each state is implemented as a block of code with an identifier (used to jump to). Hence, the next state in the Turing machine can be realized by the Go To statement, conditioned on the current state and the content of the memory (i.e. conditional branching based on constants).
(c) The tape can be implemented as a memory holding the binary representation of the elements in the alphabet. Hence, the movements in the tape can be realized by changing the address pointing to the memory.
(d) A global variable, referred to as “Address”, is used to point to the memory location equivalent to the tape section under the head.
(e) We read the memory content using its address. To write into the memory, we XOR the memory content with a constant that yields the desired value.

The following pseudo-code shows a typical state implementation (for the state with identifier “i”), where values X₁, X₂, . . . , X_{q} are constants and “Addr” is the pointer to a memory location. The example shown below illustrates the three possibilities of incrementing, decrementing and not-changing the address “Addr” variable.

| | |
|---|---|
| Block i: | |
| { | |
| Mem = Memory(Addr) | // Read data stored on the tape at the current |
| | address Addr |
| Begin switch(Mem) | |

```
      case 1:  {Memory(Addr) = XOR(Mem,X₁), Addr++,
      Go to Block j₁}
```

// If the data read equals 1, then write the
value 1⊕X₁ to the tape, move the head to the
right, and go to state j₁

```
      case 2:  {Memory(Addr) = XOR(Mem,X₂), Addr−−,
      Go to Block j₂}
```

// If the data read equals 2, then write the
value 2⊕X₂ to the tape, move the head to the
left, and go to state j₂

```
            .
            .
            .
      case q:  {Memory(Addr) = XOR(Mem,X_{q}), Addr,
      Go to Block j_{q}}
```

// If the data read equals q, then write the
value q⊕X_{q} to the tape, keep the head at its
current position, and go to state j_{q}

```
      end switch (Mem)
      }
```

Thus, any possible 5-tuple in the action table can be implemented using the XOR operation and conditional branching. Hence, a system based on the XOR operation and conditional branching is Turing complete, i.e. any Turing machine can be implemented using only XORs (for point (e) above) and conditional jumps (for point (b) above).

As shown above, it is possible to perform an operation in the transformed domain (via the function G*) that is equivalent to r=s₁⊕s₂ without ever removing the transformations on r*, s₁* or s₂*. A conditional jump is implemented using the capabilities of the programming language. This means that it is possible to implement any mathematical operation in the transformed domain without ever removing the transformations on the data elements being processed. In other words, given any function G that has u inputs α₁, . . . , αᵤ (u≧1) and v outputs β₁, . . . , βᵥ, (v≧1), a transformed version G* of the function G can be implemented, where G* is a function that has transformed versions α₁*, . . . , α*ᵤ of the inputs α₁, . . . , αᵤ as its input(s) and that outputs transformed versions β₁*, . . . , βᵥ* of the output(s) β₁, . . . , βᵥ, where αᵢ*=Tᵢ(αᵢ) and βᵢ*=Tᵢ₊ᵤ(βᵢ) for injective functions T₁, . . . , Tᵤ₊ᵥ. It is possible that two or more of the functions Tᵢ might be the same as each other. As set out above, the injective functions T₁, . . . , Tᵤ₊ᵥ may be defined (e.g. randomly generated injective functions), and, given the particular injective functions T₁, . . . , Tᵤ₊ᵥ that are defined, a particular transformed version G* of the function G results (or is defined/obtained/implemented).

The use of bijective functions T to obfuscate the implementation of a predetermined function, and the various methods of such use, are well-known in this field of technology—see, for example: “White-Box Cryptography and an AES Implementation”, by Stanley Chow, Philip Eisen, Harold Johnson, and Paul C. Van Oorschot, in Selected Areas in Cryptography: 9th Annual International Workshop, SAC 2002, St. John's, Newfoundland, Canada, Aug. 15-16, 2002; “A White-Box DES Implementation for DRM Applications”, by Stanley Chow, Phil Eisen, Harold Johnson, and Paul C. van Oorschot, in Digital Rights Management: ACM CCS-9 Workshop, DRM 2002, Washington, D.C., USA, Nov. 18, 2002; U.S. 61/055,694; WO2009/140774; U.S. Pat. No. 6,779,114; U.S. Pat. No. 7,350,085; U.S. Pat. No. 7,397,916; U.S. Pat. No. 6,594,761; and U.S. Pat. No. 6,842,862, the entire disclosures of which are incorporated herein by reference.

FIG. 4b schematically illustrates an example printed electronics device 140 according to an embodiment of the invention, namely one that the printer 120 may generate when the design file 112 is protected or secured by the protection module 113, so that the data file 116 is based on the protected design file 114. In particular, the protection module 113 is arranged to apply the above protection technique based on bijective transforms. The printed electronics device 140 of FIG. 4b is similar to the printed electronics device 140 of FIG. 4a (and therefore the same reference numerals are used where appropriate).

As shown in FIG. 4b, the protection module 113 is arranged to convert the design file 112 into the protected design file 114 so that the resulting/corresponding printed electronics device 140 comprises a first transform module 430, a second transform module 450, and transformed logic 480 that replaces the logic 440 of FIG. 4a.

The first transform module 430 is arranged to receive the data values sᵢ (i=1, . . . , m₁) and/or the data values xⱼ (j=1, . . . , m₂) and to apply one or more bijective transformations to generate transformed data values uₖ (k=1, . . . , m₅) based on the received data values. In some embodiments, each transformed data value uₖ is a transformed version of a corresponding one of the data values sᵢ (i=1, . . . , m₁) and/or the data values xⱼ (j=1, . . . , m₂) under a respective transformation Tₖ, i.e. uₖ=Tₖ(sᵢ) or uₖ=Tₖ(xⱼ) for an index i=1, . . . , m₁ or an index j=1, . . . , m₂—thus, m₅=m₁+m₂. Here, the respective transformations may be the same as each other; alternatively, uₖ₁ and uₖ₂ may have different respective transformations Tₖ₁ and Tₖ₂ for some indices 1≦k1≦k2≦m₅. Alternatively, one or more of the transformed data values uₖ is based on two or more data values from the set comprising the data values sᵢ (i=1, . . . , m₁) and/or the data values xⱼ (j=1, . . . , m₂)—for example, uₖ=Tₖ(sᵢ*,xⱼ) for some indices i and j.

The first transform module 430 is arranged to provide the transformed data values uₖ (k=1, . . . , m₅) to the transformed logic 480. As described above, the functions/operations implemented by the logic 440 of FIG. 4a can be converted into corresponding functions/operations that operate on, or use, the transformed data values uₖ (k=1, . . . , m₅) instead of the data values sᵢ (i=1, . . . , m₁) and/or the data values xⱼ (j=1, . . . , m₂). The transformed logic 480 of FIG. 4b implements these corresponding functions/operations that operate on, or use, the transformed data values uₖ (k=1, . . . , m₅).

As described above, the transformed logic 480 may generate and output one or more transformed results (or values) vₖ (k=1, . . . , m₆). The transformed logic 480 may, therefore, provide or output the transformed results vₖ to the second transform module 450. The second transform module 450 is arranged to receive the transformed results vₖ (k=1, . . . , m₆) and to apply one or more bijective transformations to generate output data tᵢ (k=1, . . . , m₃) and/or yⱼ (j=1, . . . , m₄). This is achieved in a similar manner to how the first transform module 430 operates.

The first transform module 430 and/or the second transform module 450 may implement one or more of their respective bijections using one or more respective lookup tables.

As an example, consider a situation in which a data value s; is a three-bit value, with binary representation (b₂b₁b₀) (b₁=0 or 1 for i=0, . . . , 2). The initial design file 112 may be arranged so that the logic 440 implements a function F on the data value sᵢ as illustrated in FIG. 5, i.e. r=F(sᵢ), where the binary representation of r is (r₂r₁r₀) and r₂=s₂, r₁=s₁⊕s₂ and r₀=s₀. Define the bijective transform T:GF(2⁴)→GF(2⁴) by T(x)=(11x+9)mod 15. In this example, the transform Twill be used to convert the input data value sᵢ to a transformed data value T(sᵢ) to be operated on by a transformed version of the function F, namely F^{T}, and the same transform T will be used to convert the output of the function F^{T} back to the output r. The protection module 113 would, therefore determine the transform function F^{T} so that the transformed logic 480 implements the function F^{T} instead of the function F. Thus, we need F^{T}(T(sᵢ))=T(F(sᵢ)) so that T⁻¹(F^{T}(T(sᵢ)))=F(sᵢ) for all possible values of sᵢ*=Table 1 below lists the possible values of r=F(sᵢ) for the range of possible values of sᵢ, along with corresponding values of T(sᵢ) and F^{T}(T(sᵢ)).

TABLE 1

| | Binary | Binary version | | | |
|---|---|---|---|---|---|
| sᵢ | version of sᵢ | of r = F(sᵢ) | r | T(sᵢ) | F^{T}(T(sᵢ)) |
| 0 | 000 | 000 | 0 | 9 | 9 |
| 1 | 001 | 001 | 1 | 5 | 5 |
| 2 | 010 | 010 | 2 | 1 | 1 |
| 3 | 011 | 011 | 3 | 12 | 12 |
| 4 | 100 | 110 | 6 | 8 | 0 |
| 5 | 101 | 111 | 7 | 4 | 11 |
| 6 | 110 | 100 | 4 | 0 | 8 |
| 7 | 111 | 101 | 5 | 11 | 4 |

In this example, the transform T is defined over 4-bit numbers. Thus, for all inputs other than valid values of r=T(sᵢ) (namely for inputs to the function F^{T} other than the values in the 5^{th} column of Table 1 above, i.e. values 2, 3, 6, 10, 13, 14, 15), the function F^{T} can have its corresponding output chosen to be any value, for example a random value. Thus, Table 2 may serve as an example lookup table defining the function F^{T}.

TABLE 2

| r = T(sᵢ) | Binary version of r | F^{T}(r) | Binary version of F^{T}(r) |
|---|---|---|---|
| 0 | 0000 | 8 | 1000 |
| 1 | 0001 | 1 | 0001 |
| 2 | 0010 | 5 | 0101 |
| 3 | 0011 | 13 | 1101 |
| 4 | 0100 | 11 | 1011 |
| 5 | 0101 | 5 | 0101 |
| 6 | 0110 | 8 | 1000 |
| 7 | 0111 | 12 | 1100 |
| 8 | 1000 | 0 | 0000 |
| 9 | 1001 | 9 | 1001 |
| 10 | 1010 | 2 | 0010 |
| 11 | 1011 | 4 | 0100 |
| 12 | 1100 | 12 | 1100 |
| 13 | 1101 | 5 | 0101 |
| 14 | 1110 | 6 | 0110 |
| 15 | 1111 | 13 | 1101 |

It will be appreciated that having the input to the function F above being a 3-bit value and the input and output of the transform T being a 4-bit value is purely an example, and that the input(s) to the function F may comprise any number of bits M and that the input(s) and output(s) from the transform T may similarly comprise any number of bits N, where N≧M. If N>M, then (as shown above when N=4 and M=3), it is possible to assign various values (e.g. randomly) to certain outputs from the transform T (namely to outputs of the transform T that correspond to inputs to the transform T that will not occur from valid inputs to the function F). Therefore, by having N>M, different versions of the transform T may be used (and therefore different versions of the printed electronics device 140 may be implemented), where the different versions differ from each other in the values for these particular outputs. This does not affect the normal/intended functionality of the different versions (since it is expected that the diversified outputs of the transform T will not be used in practice, since they correspond to inputs to the transform T that will not occur from valid inputs to the function F). This may be used, for example, to help identify particular batches of printed electronics devices 140 and/or to help trace individual printed electronics devices 140 and/or to help trace copies of the protected design file 114 and/or copies of the data file 116—for example, the values assigned to these outputs (i.e. the outputs of the transform T that correspond to inputs to the transform T that will not occur from valid inputs to the function F) can be used to encode or represent an identifier or identification value for use in tracing the versions. Such diversity also makes it more difficult for an attacker to perform repeat attacks using a batch of diversified printed electronics devices 140.

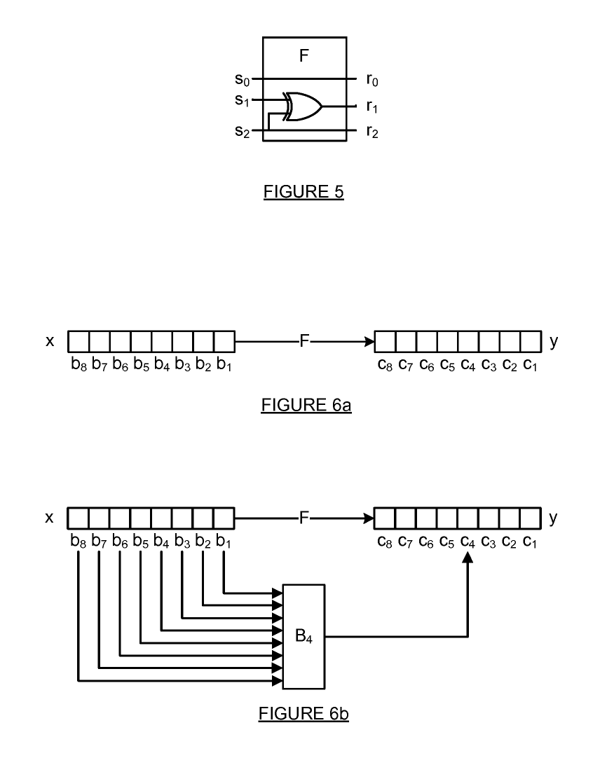

A lookup table may be implemented by one or more logical/Boolean expressions or operations, which is particularly suitable for implementation in hardware. Assume that the input to the lookup table is an input x that is an M-bit value, where the k^{th} bit of x is bₖ so that the binary representation of x is b_{M}b_{M-1} . . . b₂b₁, (so that bₖ is 0 or 1 for k=1, . . . , M). In the example described below, M=8, so that the binary representation of x is b₈b₇b₆b₅b₄b₃b₂b₁. Assume also that the output from the lookup table (i.e. the value looked-up in response to receiving the input x) is an output y that is an N-bit value, where the k^{th} bit of y is cₖ so that the binary representation of y is c_{N}c_{N-1} . . . c₂c₁, (so that cₖ is 0 or 1 for k=1, . . . , N). In the example described below, N=8, so that the binary representation of y is c₈c₇c₆c₅c₄c₃c₂c₁. This is schematically illustrated in FIG. 6a. It will be appreciated, of course, that the input x may comprise a different number of bits and that the output y may comprise a different number of bits (which may be different from the number of bits for the input x), so that having x and y both as 8-bit values is purely for illustrative purposes.

It will be appreciated that each of the output bits cₖ can be calculated or expressed as a respective logical expression Bₖ applied to the input bits bᵢ i.e. cₖ=Bₖ(b₁, b₂, . . . , b_{M}). This is schematically illustrated in FIG. 6b in respect of the output bit c₄.

The function Bₖ can be expressed using one or more logical AND's (an AND is represented herein by [symbol] ), zero or more logical OR's (an OR is represented herein by v) and zero or more logical NOT's (a NOT is represented herein by [symbol] ). In particular, suppose that the lookup table results in output bit cₖ assuming the value 1 for n input values X₁, . . . , Xₙ (i.e. when x assumes the value of any one of X₁, . . . , Xₙ), and that for all other possible values for input x, cₖ assumes the value 0. For each i=1, . . . , n, let Rᵢ be a corresponding logical expression defined by Rᵢ(b₁, b₂, . . . , b_{M})=b′_{M} [symbol] b′_{M-1} [symbol] b′_{M-2} [symbol] . . . [symbol] b′₃ [symbol] b′₂ [symbol] b′₁ (i.e. an AND of expressions b′ⱼ for j=1, . . . , M), where, for j=1, . . . , M, b′ⱼ=b₁ if the j^{th} bit bⱼ of the input value Xᵢ is a 1 and b′ⱼ= [symbol] bⱼ if the j^{th} bit bⱼ of the input value Xᵢ is a 0. For example, for the 8-bit input value Xᵢ=53 in decimal, or (00110101) in binary, then Rᵢ(b₁, b₂, . . . , b_{M})= [symbol] b₈ [symbol] [symbol] b₇ [symbol] b₆ [symbol] b₅ [symbol] [symbol] b₄ [symbol] b₃ [symbol] [symbol] b₂ [symbol] b₁. Thus, Rᵢ(b₁, b₂, . . . , b_{M}) only evaluates to the value 1 for an input value of 53. Then, Bₖ can be defined as R₁vR₂v . . . vRₙ, i.e. by OR-ing the expressions Rᵢ (i=1, . . . , n) together (if n=1, then no OR's are necessary). Then Bₖ only evaluates to the value 1 for an input that assumes the value of one of X₁, X₂, . . . , Xₙ. For example, suppose n=3 and c₄ only assumes the value of 1 if the input x takes the value 31 (=(00011111) in binary), 53 (=(00110101) in binary) or 149 (=(10010101) in binary). Then:

R₁(b₁,b₂, . . . ,b_{M})= [symbol] b₈ [symbol] [symbol] b₇ [symbol] [symbol] b₆ [symbol] b₅ [symbol] b₄ [symbol] b₃ [symbol] b₂ [symbol] b₁

R₂(b₁,b₂, . . . ,b_{M})= [symbol] b₈ [symbol] [symbol] b₇ [symbol] b₆ [symbol] b₅ [symbol] [symbol] b₄ [symbol] b₃ [symbol] [symbol] b₂ [symbol] b₁

R₃(b₁,b₂, . . . ,b_{M})=b₈ [symbol] [symbol] b₇ [symbol] [symbol] b₆ [symbol] b₅ [symbol] [symbol] b₄ [symbol] b₃ [symbol] [symbol] b₂ [symbol] b₁

so that B₄ can be expressed as

B₄(b₁,b₂, . . . ,b_{M})=( [symbol] b₈ [symbol] [symbol] b₇ [symbol] [symbol] b₆ [symbol] b₅ [symbol] b₄ [symbol] b₃ [symbol] b₂ [symbol] b₁) [symbol] ( [symbol] b₈ [symbol] [symbol] b₇ [symbol] b₆ [symbol] b₅ [symbol] [symbol] b₄ [symbol] b₃ [symbol] [symbol] b₂ [symbol] b₁) [symbol] (b₈ [symbol] [symbol] b₇ [symbol] [symbol] b₆ [symbol] b₅ [symbol] [symbol] b₄ [symbol] b₃ [symbol] [symbol] b₂ [symbol] b₁).

There are, of course, more efficient or optimized ways of expressing Bₖ, i.e. with fewer logical operations. For example, one could express B₄ above as follows:

B₄(b₁,b₂, . . . ,b_{M})=b₁ [symbol] b₃ [symbol] b₅ [symbol] [symbol] b₇ [symbol] (( [symbol] b₈ [symbol] [symbol] b₆ [symbol] b₄ [symbol] b₂) [symbol] ( [symbol] b₈ [symbol] [symbol] b₆ [symbol] [symbol] b₄ [symbol] [symbol] b₂) [symbol] (b₈ [symbol] [symbol] b₆ [symbol] [symbol] b₄ [symbol] [symbol] b₂))

and further more optimized expressions are possible. Indeed, in general, it is expected that an optimized expression may contain between 10% and 20% of the above “naïve” logical expression generated by simply OR-ing together the sub-expressions R.

Thus, the lookup table may be considered to be implemented by the functions β₁, . . . , B_{N}, so that given an input x=b_{M}b_{M-1} . . . b₂b₁, the corresponding output y=c_{N}c_{N-1} . . . c₂c₁ is defined by cₖ=Bₖ(b₁, b₂, . . . , b_{M}) for k=1, . . . , N.

Thus, the protection module 113 modifies the code or design in the design file 112 so that the protected design file 114 describes (or defines or implements) the transformed logic 480 instead of the transformed logic 440, and so that the protected design file 114 describes (or defines or implements) the first transform module 430 and the second transform module 450.

FIG. 4c schematically illustrates another example printed electronics device 140 according to an embodiment of the invention, namely one that the printer 120 may generate when the design file 112 is protected or secured by the protection module 113, so that the data file 116 is based on the protected design file 114. The printed electronics device 140 of FIG. 4c is the same as the printed electronics device of FIG. 4b except that, in FIG. 4c, the first transform module 430 may be implemented, in part, by a transform module 430a that forms part of the one or more sensors 410 (and that, therefore, applies one or more bijective transforms to the data values sᵢ (i=1, . . . , m₁) to form one or more of the data values uₖ) and/or in part by a transform module 430b that forms part of the one or more inputs 420 (and that, therefore, applies one or more bijective transforms to the data values xⱼ (j=1, . . . , m₂) to form one or more of the data values uₖ). For example, the transform module 430a may be implemented, as part of an analog-to-digital converter of one or more of the sensors 410; likewise, the transform module 430b may be implemented, as part of an analog-to-digital converter of one or more of the inputs 420. Similarly, as shown in FIG. 4c, the second transform module 450 may be implemented, in part, by a transform module 450a that forms part of the one or more transmitters 460 (and that, therefore, applies one or more bijective transforms to one or more of the data values vₖ (k=1, . . . , m₆) to yield data values tᵢ (i=1, . . . , m₃)) and/or in part by a transform module 450b that forms part of the one or more outputs 470 (and that, therefore, applies one or more bijective transforms to one or more of the data values vₖ (k=1, . . . , m₆) to yield data values yⱼ (j=1, . . . , m₄)). For example, the transform module 450a may be implemented, as part of a digital-to-analog converter of one or more of the transmitters 460; likewise, the transform module 430b may be implemented, as part of a digital-to-analog converter of one or more of the outputs 470.

By implementing data transformations within the sensors 410 and/or inputs 420 and/or transmitters 460 and/or outputs 470, the overall security and tamper resistance is increased.

Various software protection techniques, for protecting an item of software against white-box attacks, are known and implemented using various programming languages, such as C++. Annex A below discusses how such known techniques can be applied and adapted to protect HDL code in the design file 112 to generate the protected design file 114 (which may comprise obfuscated HDL code and/or an obfuscated netlist).

### 3—Additional Protection

In some embodiments of the invention, the protection module 113, in addition to applying the one or more protection techniques to provide the security-related operation with resistance against a hardware attack, may modify the design file 112 to form the protected design file 114 so that the resulting printed electronics device 140 comprises one or more additional security modules, as described below. Some or all of the one or more security modules may, themselves, be implemented so as to have resistance against a hardware attack. For example, the protection module 113 could add code to the design file 112 that implements the functionality of a security module and then applying the one or more protection techniques to both the code for both that security module and the security-related operation. Each security module is arranged to detect that an attack may be taking place (or may be being performed or may have been performed) by an attacker—different security modules may detect or respond to different types of attack. If a security module detects that an attack may be taking place, or may have taken place, then the security module may be arranged to take one or more predetermined actions, such as causing the printed electronics device 140 to cease functioning (either temporarily or permanently), or to cause the printed electronics device 140 to output random data or meaningless data, etc.

In some embodiments, one of the security modules is arranged to perform a test to check whether the printed electronics device 140 operates as expected (i.e. operates according to one or more predetermined criteria, that indicate that normal operation is being conducted). This check (or test or assessment) may be performed periodically and/or at power up of the printed electronics device 140. This check could comprise, for example, a built-in-self-test. This check could comprise monitoring data paths for undefined data values in the transformed domain. For example, as discussed above, there may be one or more values for one or more inputs to a transformed function F^{T} and/or one or more values for one or more outputs of the transformed function F^{T} that should not occur during normal operation. For instance, as shown in Tables 1 and 2 above, the inputs and outputs of that particular transformed function F^{T} should never assume one of the values: 2, 3, 6, 7, 10, 13, 14 or 15. If an input or output assumes an invalid value, then it is possible that an attacker is trying to attack the printed electronics device 140. If the security module detects, via the check(s), that the printed electronics device 140 is not operating as expected, then the security module may consider there to be an attack being performed by an attacker—the security module may then operate in response to the attack as discussed above.

In some embodiments, the protection module 113 may be arranged so that the transformed logic 480 comprises multiple instances or implementations of the same calculation (or operation or function) so that, when the printed electronics device 140 is operating normally, these multiple instances or implementations should all provide corresponding outputs. This, effectively, introduces redundant calculations. One of the security modules may, therefore, be arranged to monitor the multiple instances or implementations to check that their outputs do indeed all correspond. If the security module detects that these outputs do not all correspond, then the security module may consider there to be an attack being performed by an attacker—the security module may then operate in response to the attack as discussed above. This therefore forces an attacker to modify multiple parts of the implementation, which makes it harder for the attacker to be successful.

In some embodiments, various data values may be expected to meet certain criteria or constraints, or may be expected to have certain properties. For example, during normal operation, the processing that is performed by the transformed logic 480 may be such that: the data value x₁ should always be greater than the data value x₂; or the data value x₁ should only ever be in the predetermined range from a to b; or the data value x₁ should always be negative; etc. One of the security modules may, therefore, be arranged to monitor these various data values and their associated criteria/constraints/properties. If the security module detects that one or more of these various data values do not meet or satisfy their associated criteria/constraints/properties, then the security module may consider there to be an attack being performed by an attacker—the security module may then operate in response to the attack as discussed above.

In some embodiments, one or more of the security modules is a sensor arranged to detect one or more physical attacks to the printed electronics device 140. In some embodiments, the sensor detects the attack when power is applied to the printed electronics device 140; in other embodiments, the sensor detects the attack when the printed electronics device 140 is in a standby/off mode, in which case the printed electronics device 140 may comprise a power source or battery for this particular sensor.

In this way, the above-mentioned security module(s) therefore implement one or more of (i) an integrity verification operation, (ii) a tamper detection operation; and (iii) detection of an attack being performed against the printed electronics device 140.

As mentioned above, the printed electronics device 140 may be connected to, or attached to, another item or object 150 to generate a new item or object 160.

In one embodiment, the printed electronics device 140 is generated so that it has a protective layer of material covering a “sensitive part” of the printed electronics device 140. The protective layer may be formed as part of the printing process by the printer 120, or may be applied subsequent to the printer 120 printing the printed electronics device 140. The “sensitive part” may be a part (or section or area) printed using one or more chemicals that are sensitive to air and/or moisture/humidity—if the sensitive part were exposed to air and/or moisture/humidity, then the sensitive part may be damaged, thereby preventing operation of the printed electronics device 140. The protective layer of material therefore prevents air and/or moisture/humidity from coming into contact with the sensitive part, i.e. without the protective layer, the sensitive part of the printed electronics device 140 would be exposed to air and/or moisture/humidity (e.g. the sensitive part may form at least part of a surface of the printed electronics device 140). The item 150 may comprise one or more pins and the printed electronics device 140 may be attached to the item 150 in a manner so that the pins punch through, or piece, the protective layer. Therefore, if the printed electronics device 140 is removed from the item 150, then the sensitive part of the printed electronics device 140 may be exposed to air and/or moisture/humidity due to the holes in the protective layer that are no longer blocked by the pins. In this way, removal of the printed electronics device 140 from the item 150 may be arranged to damage/destroy the printed electronics device 140.

The printed electronics device 140 may be attached to the item 150 using a strong glue (or adhesive). The strength of the glue may be selected so that if the printed electronics device 140 is removed from the item 150, the printed electronics device 140 will be broken.

The above-described techniques are physical and chemical means for ensuring that the printed electronics device 140 remains attached to the item 150. One or more of the above-mentioned security modules may be arranged to facilitate this too. Thus, one or more of the above-mentioned security modules may be arranged to perform one or both of (i) an operation to verify one or more predetermined properties of an object/item 150 to which the printed electronics device 140 is connected and/or (ii) an operation to verify that the printed electronics device 140 is connected to the object/item 150. This is discussed in more detail below.

One or more of the security modules may comprise a sensor to detect the presence of the item 150. If the sensor does not detect the presence of the item 150, then the security module may consider there to be an attack being performed by an attacker (or that an attack has already been performed)—the security module may then operate in response to the attack as discussed above.

One or more of the security modules may comprise a sensor that detects or measures a property or characteristic of the item 150 and then compares the detected or measured property or characteristic with reference data—if the measured property or characteristic does not match the reference data (or does not match sufficiently closely) then the security module may consider there to be an attack being performed by an attacker (or that an attack has already been performed)—the security module may then operate in response to the attack as discussed above. For example, the sensor may measure the electrical impedance of the item 150 and compare this impedance to a predetermined value. If the measured impedance is not sufficiently close to the predetermined value (i.e. within a threshold around the predetermined value), then the security module may consider there to be an attack being performed by an attacker (or that an attack has already been performed)—the security module may then operate in response to the attack as discussed above.

As another example, the area on the item 150 at which the printed electronics device 140 is in contact with the item 150 (referred to below as the “contact area”) may comprise one or more patterns or properties. For example, the contact area may comprise a random pattern or properties that occur simply due to the manufacturing of the item 150 which causes random irregularities (e.g. bumps and grooves) on the contact area. Thus, in some embodiments, the contact area is physically unclonable. Therefore, in some embodiments, one or more of the security module(s) may comprise a sensor for detecting a pattern on, or one or more properties of, the contact area. This can be used in numerous ways, for example:
In one embodiment, when the printed electronics device 140 is first attached to the item 150, the security module may be initialised—this involves the security module using its sensor to read or detect the pattern on the contact area and storing a representation of that pattern. When the printed electronics device 140 is used (i.e. during “normal” operation), the security module may be arranged to read or detect a current pattern on the contact area and to compare the current pattern with the stored representation. If they do not match then this is indicative of the printed electronics device 140 having been removed from its initial item 150 and attached to another item 150—therefore, the security module may then consider there to be an attack being (or have been) performed by an attacker and the security module may then operate in response to the attack as discussed above.
In one embodiment, when the printed electronics device 140 is first attached to the item 150, the security module may use its sensor to read or detect the pattern on the contact area and provide a representation of that pattern as an output. This output may be provided, for example, to an authentication system—the authentication system may then store the representation for use in authenticating future interactions with the printed electronics device 140. For example, when the printed electronics device 140 is used (i.e. during “normal” operation), the security module may be arranged to read or detect a current pattern on the contact area and to use the current pattern (or a representation of the current pattern) as an input sᵢ to the security-related function. For example, the current pattern (or its representation) may be used, at least in part, to help determine a cryptographic key for performing a cryptographic operation (such as encrypting, or generating a hash of, a nonce provided by the authentication system). The output of the cryptographic operation may be provided to the authentication system. As the authentication system stores the original representation, then the authentication system can be arranged to perform the same cryptographic operation as performed by the printed electronics device 140, based on the stored representation, and to compare the output of the cryptographic operation performed by the authentication system with the output of the cryptographic operation performed by the printed electronics device 140. If the printed electronics device 140 has not been removed from the original item 150, the two outputs should match. Therefore, if the two outputs match then the authentication system may verify that the printed electronics device 140 is attached to the “correct” item 150; if the two outputs do not match then the authentication system may determine that the printed electronics device 140 is not attached to the “correct” item 150.

### 4—Example Uses

In one embodiment, the printed electronics device 140 is used to form a smart card (for example, a smart card for use with a digital broadcast set top box). The printed electronics device 140 produced by the printer 120 may be the final smart card itself; alternatively, the printed electronics device 140 may be attached to a plastic card (the item 150), thereby resulting in a smart card (i.e. the item 160). As is known, smart cards perform various security-related operations (such as conditional access or digital rights management functionality for controlling access to digital content) which may be protected against hardware attacks as described above.

In one embodiment, the printed electronics device 140 (or the item 160 that comprises the printed electronics device 140) may be used as a so-called “smart label”. A smart label is a device or apparatus that is arranged to store, and provide/output, information in relation to an object (or product) to which the smart label is attached. The information may be any kind of information, such as an identification code for that particular object, information relating to an origin (e.g. location and/or date of creation/manufacture) for the object, information providing detail (e.g. metadata or a description) about the object, etc. The printed electronics device 140 may output the information via, for example, a transmitter 460 (such as a wireless transmitter).

In some embodiments, the security-related function for the smart label may comprise encrypting and/or digitally signing the information, so that smart label can output the information in manner that protects the integrity of the information and/or enables authentication of the origin of the information. This is particularly useful, for example, when the information comprises an identifier (e.g. a unique identification code) for the object. In particular, a user's device (such as a mobile telephone, computer, sales terminal, etc.) may receive the identifier from the printed electronics device 140 and perform a verification operation. For the verification operation, the user's device may, for example, send an authentication request to an authentication system (for example via the internet or some other network), where the authentication request comprises the identifier and, in response to the received request, the authentication system determines whether the identifier in the request corresponds to an authentic object (for example by comparing the received identifier with authentic identifiers stored in a database of the authentication system) and report back to the user's device accordingly.

In some embodiments, the authentication request may comprise additional data to facilitate authentication processing by the authentication system. For example, security can be increased if, for example, the authentication request comprises a representation of a pattern of a contact area, as described above—if the database used by the authentication system stores the identifier in association with the representation of the pattern, then the authentication system can check whether the authentication request comprises a valid identifier for a valid pattern. Similarly, security can be increased if, for example, the authentication request comprises a location of the user's device or a location of the printed electronics device 140. The authentication system may then be arranged to determine the time difference T between the current authentication request and a previous authentication request associated with the identifier in the authentication request (for example by storing the date/time of received authentication requests in the database) and the authentication system may also be arranged to determine a distance or a difference D between the location for the current authentication request and the location for the previous authentication request (for example by storing the locations of received authentication requests in the database). If the distance or difference exceeds a threshold based on the time difference (for example if D/T is greater than a predetermined threshold), then the authentication system may determine that the printed electronics device 140 has been cloned, and so may respond to the authentication request with an “authentication failure” message. It will be appreciated that embodiments of the invention may make use of location data and/or other environmental data provided in authentication requests in other ways.

In some embodiments, the authentication system may store, in association with the identifier of the printed electronics device 140, secret data (such as a cryptographic key, e.g. a symmetric key) that the printed electronics device 140 also stores (and that is protected against attacks as described above). The authentication processing performed by the authentication system may, therefore, involve the authentication system providing to the printed electronics device 140 a challenge—the challenge may comprise a nonce, random data, or any other unpredictable data, or any data that has not been previously used in previous challenges to the printed electronics device 140. The printed electronics device 140 may be arranged to perform a cryptographic operation (such as an encryption operation or generation of a hash) on the challenge using, or based on, the secret data, and to provide to the authentication system, in response to the challenge, a message that comprises both the identifier and the result of the cryptographic operation. The authentication system, upon receiving the message, may authenticate the message—the authentication system knows both the challenge and the secret data and so can, itself, perform the cryptographic operation on the challenge using, or based on, the secret data stored by the authentication system. If the result of the cryptographic operation that the authentication system performs matches the result contained in the message, then the authentication system considers the message to be authentic and can return an “authentication success” message; otherwise, the authentication system considers the message to not be authentic and can return an “authentication failure” message. With this embodiment, cloning of devices is more difficult as replay attacks are no longer possible.

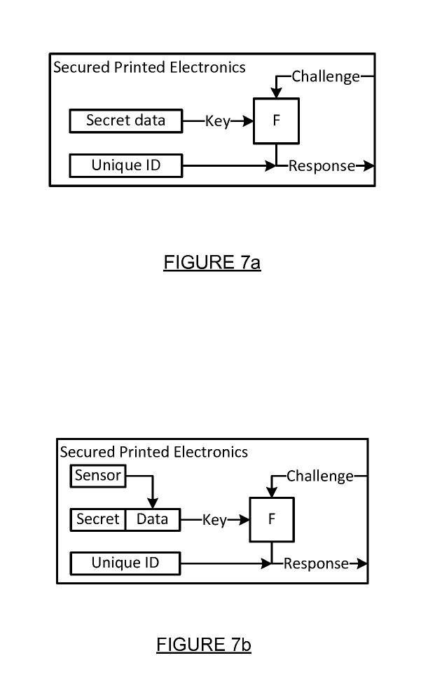

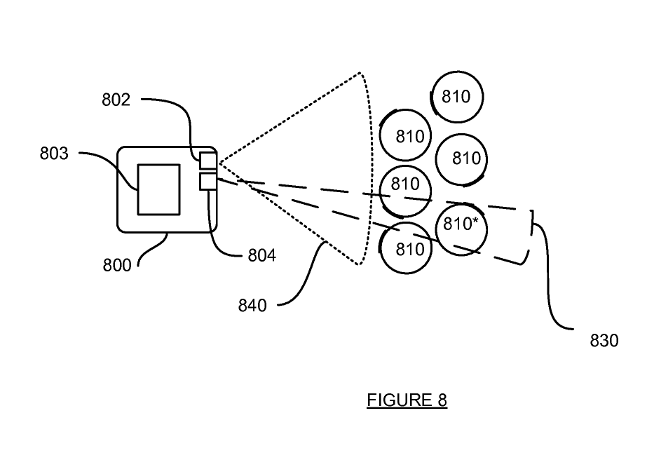

FIG. 7a schematically illustrates the processing for the printed electronics device 140 according to the above embodiment.

This embodiment may be extended further as follows. In particular, the cryptographic operation, in addition to using or being based on the secret data, may use, or be based on, an output from one or more of the sensors 410 of the printed electronics device 140. For example, the cryptographic operation may be additionally based on the pattern of the contact area on the item 150. The authentication system may be arranged to store a valid value (i.e. an expected value) for the output from the one or more of the sensors 410, so that the authentication system can still perform the same cryptographic operation as performed by the printed electronics device 140. For example, a key for the cryptographic operation may be formed based on the secret data and the output from the one or more of the sensors 410—if the printed electronics device 140 has not been tampered with, then both the printed electronics device 140 and the authentication system will generate the same result from the cryptographic operation as they will use the same key; if the printed electronics device 140 has been tampered with, then the printed electronics device 140 and the authentication system will generate the different results from the cryptographic operation as they will use different keys.

In this embodiment, the one or more sensors 410 whose output is used for the cryptographic operation may comprise a sensor 410 that detects or determines one or more properties of the object to which the smart label is attached. For example, the output of the sensor 410 may identify, or relate to, one or more important aspects or properties of object (such as aspects that affect the value of the object, such as whether a packaged object has been opened or whether the object has been used).

FIG. 7b schematically illustrates the processing for the printed electronics device 140 according to the above embodiment.

The smart label may, for example, be attached to a medicine package and may, therefore, be arranged to securely store dosage/prescription/usage instructions for the medicine. Likewise, the above-mentioned functionality can also be used to ensure that the smart label will only operate correctly if it is attached to the correct/initial medicine package, thereby helping preventing misuse of the medicine.

In one embodiment, the printed electronics device 140 (or the item 160 that comprises the printed electronics device 140) may be used as a so-called “smart sensor”. A smart sensor comprises one or more sensors 410 that, for example, measure one or more properties of an environment in which the printed electronics device 140 is located, such as temperature, ambient light level, sound volume, presence of a person, electric energy consumption, the sounds of breaking glass, etc. The security-related operation may be arranged to secure the measurements provided by the one or more sensors 410, for example by encrypting or digitally signing data representing the measurements, so that the printed electronics device 140 may output secured measurement data. This helps prevent attackers from accessing or using or modifying measurement data output from, or transmitted by, the smart sensor.

FIG. 8 schematically illustrates another embodiment of the invention. In particular, a user of a mobile device 800 (such as a mobile telephone, tablet computer, a pair of “smart glasses”, a “smart watch”, etc.) wishes to connect the mobile device 800 with a particular electronics device 810* from a set of electronics devices 810 in the locality of the mobile device 800 (i.e. a wireless data communications link is to be created between the mobile device 800 and the particular electronics device 810*). The electronics devices 810 (including the particular electronics device 810*) may be secured printed electronics device as discussed above, but this need not necessarily be the case. If an electronics device 810 is a secured printed electronics devices as discussed above, it may be, for example, a smart sensor or a smart label. The mobile device 800 may comprise a secured printed electronics device (as described above) that performs some or all of the functionality of the mobile device 800 described below.

The mobile device 800 comprises a camera 802, a screen (or display) 803 for displaying or outputting a visual representation (or an image) of one or more images captured by the camera 802, and a wireless communications interface 804 (such as a radio frequency network interface). The communications interface 804 may be, for example, a WiFi or Bluetooth communications interface 804. The communications interface 804 is a suitable wireless communications interface for communicating with one or more of the electronics devices 810 (including the particular electronics device 810*)—thus, these electronics devices 810 also comprise a corresponding wireless communications interface (not shown in FIG. 8).

The mobile device 800 comprises a processor. The processor is arranged to execute a software application to perform functionality as set out below to control the camera 802 and the communications interface 804. However, it will be appreciated that, instead, some or all of this functionality could be implemented in hardware as part of the mobile device 800.

The mobile device 800, using the software application, is arranged to:
(a) Control the camera 802 so as to capture an image. FIG. 8 illustrates an optical field of view 840 of the camera 802. Thus, the image captured by the camera 802 may include one or more of the electronics devices 810 (including the particular electronics device 810*), or at least a representation of the electronics devices 810 (including the particular electronics device 810*). In some embodiments, the software application uses the camera 802 to capture the image in response to a command or input from a user of the mobile device 800 (such as by the user pressing a button on the mobile device 800 or by providing some input to the software application via an interface provided by the software application).
(b) Allow the user to select a part of the captured image. This may comprise, for example, the user selecting a point on the captured image (for example, by pressing a point on the screen 803), or the user defining or drawing or indicating an area of the image (for example, by drawing a perimeter of the area). Thus, the screen 803 may be touch sensitive to enable the user to provide such an input. Alternatively, the mobile device 800 may be arranged to receive input from a user via other means, such as via one or more buttons or controls or one or more sensors to detect an operation or input or action of the user (such monitoring one or both of the user's eyes to detect a position on the captured image that the user is looking at). It will be appreciated that the selection mechanism is not an important aspect of this embodiment of the invention, so that any selection mechanism may be used.
   The part of the captured image that the user selects is a part that represents, or depicts or corresponds to, the particular electronics device 810*.
(c) Based on the selected part, control the wireless communications interface 804 to establish a wireless data communications link with the electronics device 810 that corresponds to the selected part of the captured image.
The wireless communications interface 804 may be arranged to output a directed RF beam 830, as shown in FIG. 8, and the software application may, therefore, control or instruct the wireless communications interface 804 to steer the RF beam 830 so that the RF beam 830 is directed towards the electronics device 810 (namely the the particular electronics device 810*) that corresponds to the selected part of the captured image. The establishment of the wireless data communications link between the mobile device 800 and the particular electronics device 810* may then proceed according to any conventional wireless communications protocol.
In some embodiments (particularly suitable for mobile devices 800 for which the wireless communications interface 804 is not able to steer the RF beam 830), the software application may be arranged to poll one or more of the electronics devices 810 sequentially. For example, the wireless communications interface 804 may have detected the presence of one or more of the electronics devices 810 and may, then, cycle through the detected electronics devices 810. In particular, the software application may be arranged to request, in turn, that each detected electronics device 810 provides an output or a feedback signal to the mobile device 800 (for example, by activating a light source) that the mobile device 800 (either via the camera 802 or the wireless communications interface 804) can receive. The software application may then determine whether the received output/signal from an electronics device 810 corresponds to the selected part of the captured image. For example, the software application may be arranged to: (a) capture one or more images at a point in time at which a polled electronics device 810 activates (or is expected to have activated) its light source; (b) detect whether this captured image has a part that corresponds to the selected part of the initially captured image; (c) if so, detect whether that part depicts an activated light source (e.g. by comparing the initially captured image with the one or more newly captured images to look for a bright spot) and (d) if so, that polled electronics device 810 is the particular electronics 810* with which a wireless data communication links should be established.

### 5—Modifications

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

### ANNEX A

Over recent years there has been a large increase in the number of end user computer devices for which programmers provide software, much of this increase being in the realm of devices for mobile telephony and mobile computing, including smart phones, tablet computers and the like, but also in the realm of more traditional style desktop computers as well as computers embedded in other manufactured goods such as cars, televisions and so forth. A large part of the software provided to such devices is in the form of applications commonly referred to as “apps”, and this software may typically be provided in the form of native code, scripting languages such as JavaScript, and other languages such as Java.

Often, such software, and data or content which the software is used to mediate to a user, is at risk of compromise if the software is not suitably protected using various software protection techniques. For example, such techniques may be used to make it very difficult for an attacker to extract an encryption key which could be used to gain unauthorised access to content such as video, audio or other data types, and may be used to make it very difficult for an attacker to replicate software for unauthorised use on other devices.

However, the use of such software protection techniques can lead to a reduction in the performance of the software, for example decreasing execution speed, increasing the amount of memory needed to store the software on a user device, or increasing the memory required for execution. Such software protection techniques may also be difficult to apply across a wide range of different software types, for example pre-existing software written in different source code languages or existing in particular native code formats.

It would be desirable to be able to provide protection against attacks for items of software, and to provide such protection across a range of software representations such as different source code languages and native code types, while also maintaining good levels of performance of the software on end user devices. It would also be desirable to deliver software suitably protected in this way for use on multiple different platform types.

We therefore describe a unified security framework in which the advantages of software tools in a first collection which are used for translation between representations, for optimization, compilation and so forth, are combined with the advantages of software tools in a second collection which are used for protection of software. In one example, the software tools in the first collection may be tools of the LLVM project, which generally operate using the LLVM intermediate representation. However, tools from other collections which operate using other intermediate generalisations may be used, for example tools from the Microsoft common language infrastructure, which typically use the common intermediate language CIL. Below, the intermediate representation used by the software tools in the first collection will be denoted as a first intermediate generalisation. Note that software tools in the first collection may also include tools for protection of software, such as binary rewriting protection tools.

An intermediate representation is a software representation which is neither originally intended for execution on an end user device, nor originally intended for use by a software engineer in constructing original source code, although either such activity is of course possible in principle. In the described below, neither the original software input to the unified security framework, nor the transformed software output for use on end user devices is cast in an intermediate representation.

The software tools in the second tool collection use a different intermediate generalisation, which is typically better suited, or originally intended for use by software tools which apply security protection transformations to items of software processed by the unified security framework. This intermediate representation is generally denoted below as the second intermediate representation, and is different to the first intermediate representation. The second intermediate representation may be designed in such a manner such that source code in languages such as C and C++ can be readily translated into the second intermediate representation, and from which source code in the same or similar languages can be readily reconstructed, by suitable conversion tools.

More generally, the unified security framework is described in which software tools for applying security transformations to items of software are provided such that multiple security transformation steps may be carried out, for example successively on an item of software, in multiple different intermediate representations. The unified security framework may also provide software tools for applying optimization transformations to items of software such that multiple optimization transformation steps may be carried out, for example successively on an item of software, in multiple different intermediate representations.

The described arrangements may be used to accept an input item of software in any input language or native code/binary representation for optimization and protection, and to output the protected and optimized item of software in various forms including any desired native code/binary representation, JavaScript or a subset of JavaScript, etc. In some examples the input representation, for example a particular binary code, may be the same as the output representation, thereby carrying out optimization and protection on an existing binary code item of software.

To this end, we describe a method comprising carrying out optimization of an item of software in a first intermediate representation, and carrying out protection of the item of software in a second intermediate representation which is different to the first intermediate representation.

The optimization in the first intermediate representation may be carried out both before and after carrying out protection in the second intermediate representation, and the method may therefore comprise converting the item of software from the first intermediate representation to the second intermediate representation after carrying out optimization a first time and before subsequently carrying out protection, and converting from the second intermediate representation to the first intermediate representation after carrying out protection and before subsequently carrying out optimization a second time.

Similarly, the protection in the second intermediate representation may be carried out both before and after carrying out optimization in the first intermediate representation, and the method may therefore comprise converting the item of software from the second intermediate representation to the first intermediate representation after carrying out protection a first time and before subsequently carrying out optimization, and converting from the first intermediate representation to the second intermediate representation after carrying out optimization and before subsequently carrying out protection a second time.

Steps of protection and optimization in the relevant intermediate representations can be carried out alternately any number of times, starting with either protection or optimization, and proceeding with one or more further steps in an alternating fashion.

As mentioned above, the first intermediate representation may be LLVM intermediate representation, LLVM IR, although other intermediate representations could be used such as Microsoft CIL.

More generally, we describe a method to carry out optimization of an item of software using optimization steps carried out in one or more intermediate representations, and carrying out protection of the item of software using protection steps in one or more intermediate representations some or all of which may be the same as or different to the intermediate representations used for carrying out the optimization.

The optimization may comprise various types of optimization, for example for one or more of size, runtime speed and runtime memory requirement of the item of software. Techniques to achieve such optimizations may include vectorization, idle time, constant propagation, dead assignment elimination, inline expansion, reachability analysis, protection break normal and other optimizations.

Protection of the item of software in the second intermediate representation comprises applying one or more protection techniques to the item of software, in particular security protection techniques which protect program and/or data aspects of the software from attack. Such techniques may include, for example, white box protection techniques, node locking techniques, data flow obfuscation, control flow obfuscation and transformation, homomorphic data transformation, key hiding, program interlocking, boundary blending and others. The techniques used may be combined together in various ways to form one or more tools, for example as a cloaking engine implemented as part of an optimization and protection toolset.

The item of software is provided in an input representation which is typically different to both of the first and second intermediate representations. The method therefore may involve converting the item of software from the input representation to the first intermediate representation before carrying out the optimization, and typically also before carrying out the protection mentioned above. In some examples, the item of software in the input representation is converted to the second intermediate representation and then converted from the second intermediate representation before the first optimisation, and optionally also before the protection is carried out.

The input representation may be a source code representation such as C, C++, Objective-C, Java, JavaScript, C#, Ada, Fortran, ActionScript, GLSL, Haskell, Julia, Python, Ruby and Rust. However, the input representation may instead be a native code representation, for example a native code (i.e. a binary code) representation for a particular processor family such as any of the x86, x86-64, ARM, SPARC, PowerPC, MIPS, and m68k processor families. The input representation could also be a hardware description language (HDL). As is well-known, an HDL is a computer program language that may be used to program the structure, design and operation of electronic circuits. The HDL may, for example, be VHDL or Verilog, although it will be appreciated that many other HDLs exist and could be used in examples instead. As HDLs (and their uses and implementations) are well-known, they shall not be described in more detail herein, however, more detail can be found, for example, at http://en.wikipedia.org/wiki/Hardware_description_language, the entire disclosure of which is incorporated herein by reference.

When the above optimization and protection processes have been carried out, the item of software may be converted to an output representation. This stage of processing may also include further optimization and/or protection stages. In some examples, converting the item of software to an output representation comprises compiling (and typically also linking) the item of software into the output representation, for example into a native code representation. Further binary protection techniques may then also be applied to the item of software after the compiling and linking.

Before compilation, the item of software may be first converted from the first to the second intermediate representation and on to a source code representation which is passed to the compiler, or the item of software could be passed to the compiler directly in the first intermediate representation. In the first case, a compiler operating on the source code representation, such as a C/C++ compiler could be used. In the second case an LLVM compiler could be used if the first intermediate representation is LLVM IR. In any case, the compiler may be an optimizing compiler in order to provide a further level of optimization to the protected item of software.

Converting the item of software to an output representation may also comprise applying a binary rewriting protection tool to the item of software in the first intermediate representation before compiling, and/or such a tool may be applied at other times in the process.

Instead of compiling the item of software into a native code representation, the item of software may instead be converted into a script representation, and especially into a script representation which can be executed on an end user device. Conveniently, a JavaScript representation may be used for this purpose because such a script can be executed directly by a web browser on the end user device. More particularly, an asm.js representation, which is a subset of JavaScript, may be used, because asm.js is adapted for particularly efficient execution on end user devices. For example, if the first intermediate representation is the LLVM IR, then the Emscripten tool may be used to convert the item of software from the first intermediate representation to an asm.js representation.

If the input representation is a hardware description language then the output representation may typically be in a corresponding representation able to describe the electronic circuit at a more hardware oriented level, such as in a netlist. Where processing aspects such as compilation and linking are described herein, the skilled person will appreciate that when the described arrangements are used with an HDL input representation, equivalent steps such as synthesis using appropriate tools may be used, and that suitable software tools applicable to HDL work may be used for the protection and optimization aspects of the described arrangements. The output item of software is then a description of the electronic system with suitable obfuscation/protection and optimization steps applied.

The item of software may be any of a variety of items of software, such as an application for execution on a user device, a library, a module, an agent, and so forth. In particular, the item of software may be an item of security software such as a library, module or agent containing software for implementing security functions such as encryption/decryption and digital rights management functions. The method may be applied to two such items of software, and one of these items of software may use functionality in the other for example through a procedure call or other reference. Similarly, an item of software optimized and protected according to the described examples may utilize or call security related or protected functionality in lower layers such as a systems layer or hardware layer. Similarly, the item of software may describe an electronic system, and be provided for input to the example arrangements in an HDL.

We also describe a method of protecting an item of software comprising applying one or more protection techniques to the item of software, and optimizing the item of software using one or more LLVM tools, and this aspect of the may be combined with the various options mentioned elsewhere herein. For example, the one or more protection techniques may be applied to the item of software using a protection component arranged to operate using an intermediate representation which is different to the LLVM intermediate representation, and the method may further comprise converting the item of software between one or more representations and the LLVM intermediate representation using LLVM tools. The method may be used to output a protected and optimized item of software in one of asm.js or a native code representation.

Following processing of an item of software as discussed above, the item of software may be delivered to one or more user devices for execution. The item of software may be delivered to user devices in various ways such as over a wired, optical or wireless network, using a computer readable medium, and in other ways.

The software for providing the discussed methods and apparatus may be provided on one or more computer readable media, over a network or in other ways, for execution on suitable computer apparatus, for example a computer device comprising memory and one or more processors, or a plurality of such devices, in combination with suitable input and output facilities to enable an operator to control the apparatus such as a keyboard, mouse and screen, along with persistent storage for storing computer program code for putting the described arrangements into effect on the apparatus.

We therefore also describe computer apparatus for protecting an item of software, comprising an optimizer component arranged to carry out optimization of the item of software in a first intermediate representation, such as LLVM IR, and a protector component arranged to carry out protection of the item of software in a second intermediate generalisation.

The apparatus may be arranged such that the optimizer component carries out optimization in the first intermediate representation of the item of software both before and after the protector component carries out protection in the second intermediate representation of the item of software.

The optimization component may comprise one or more LLVM optimization tools.

The protection component may be arranged to apply to the item of software one or more protection techniques comprising one or more of white box protection techniques, node locking techniques, data flow obfuscation, control flow obfuscation and transformation, homomorphic data transformation, key hiding, program interlocking and boundary blending.

The apparatus may further comprise an input converter arranged to convert the item of software from an input representation to LLVM IR, and the input representation may be one of a binary or native code representation, a byte code representation, and a source code representation. The apparatus may further comprise a compiler and linker arranged to output the optimized and protected item of software as binary code, and an output converter arranged to output the optimized and protected item of software as asm.js code.

We also describe a unified cloaking toolset comprising a protection component, an optimizer component, and one or more converters for converting between intermediate representations used by the protection component and the optimizer component. The optimizer component may comprise one or more LLVM optimizer tools, and the unified cloaking toolset may comprises one or more LLVM front end tools for converting from an input representation into LLVM intermediate representation. The unified cloaking toolset, protection components and/or optimizer components may be provided to apply transformations to an item of software in more than one intermediate representation.

The unified cloaking toolset may also implement the various other aspects of the described examples as set out herein, for example with the protection component implementing one or more of the following techniques: white box protection techniques, node locking techniques, data flow obfuscation, control flow obfuscation and transformation, homomorphic data transformation, key hiding, program interlocking, and boundary blending; the unified cloaking toolset further comprising a compiler and linker arranged to compile and link into a native code representation; and the unified cloaking toolset further comprising an output converter for converting to an output representation which is a subset of JavaScript.

This description also covers one or more items of software which have been optimized and protected using the described methods and/or apparatus, and such items of software may be provided, stored or transferred in computer memory, on a computer readable medium, over a telecommunications or computer network, and in other ways.

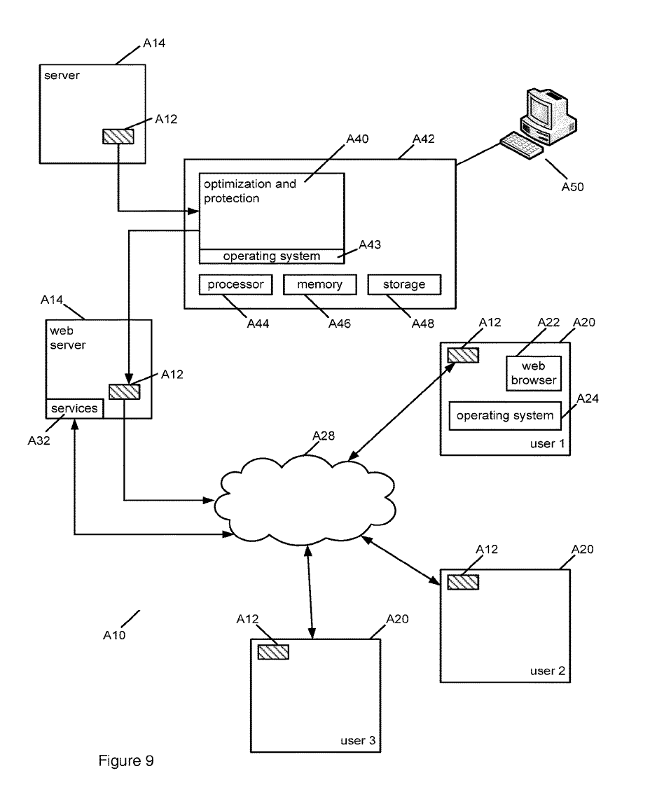

Various examples will now be described, with reference to FIGS. 9-18.

In the description that follows and in the figures, certain examples are described. However, it will be appreciated that the ideas in this discussion are not limited to the examples that are described and that some implementations of the ideas may not include all of the features that are described below. Referring now to FIG. 9 there is shown an exemplary computer system. An item of software A12 is provided, for example by a server A14 where it has been previously stored. The item of software A12 may be intended for various different purposes, but in the system of FIG. 9 it is an application (sometimes referred to as an app, depending on aspects such as how the application is delivered and how it is used in the context of the user device and wider operating environment) which is intended for execution and use on one or more of a plurality of user computers A20. The user computers A20 may be personal computers, smart phones, tablet computers, or any other suitable user devices. Typically, such a user device A20 will include an operating system A24 providing services to other software entities running on the user device such as a web browser A22. The item of software A12 may be delivered to the user device in various forms, but typically may be in the form of native executable code, a generic lower level code such as Java byte code, or a scripting language such as Java script. Typically, a generic lower level code or a scripting language software item A12 will be executed within or under the direct control of the web browser A22. An item of software A12 in native executable code is more likely to be executed under the direct control of the operating system A24, although some types of native code such as Google NaCl and PNaCl are executed within a web browser environment.

The item of software A12 of FIG. 9 may typically be delivered to the one or more user devices over a data network A28 such as the Internet by a remote web server A30, although other delivery and installation arrangements may be used. The illustrated web server, or one or more other servers, may also provide data, support, digital rights management and/or other services A32 to the user devices A20 and in particular to the item of software A12 executing on the user devices A20.

The item of software A12 may be vulnerable to attack and compromise in various ways on the user devices A20, whether before, during or after execution on those devices A20. For example, the item of software may implement digital rights management techniques which an attacker may try to compromise for example by extracting an encryption key or details of an algorithm which can enable future circumvention of the digital rights management techniques for that particular item of software, for particular digital content, and so forth.

The system A10 therefore also provides an optimization and protection toolset A40 which is used to optimize and protect the item of software A12 before delivery to the user devices A20. In FIG. 9 the optimization and protection toolset A40 acts upon the item of software A12 before the item of software A12 is delivered to the web server A32, but it could be implemented in the server A14, the web server A30, in a development environment (not shown) or elsewhere. The optimization and protection toolset A40 in FIG. 9 is shown as executing on a suitable computer apparatus A42 under the control of an operating system A43. The computer apparatus A42 will typically include one or more processors A44 which execute the software code of the optimization and protection toolset A42 using memory A46, under control of a user through input/output facilities A50. The computer apparatus A42 and functionality of the optimization and protection toolset A40 could be distributed across a plurality of computer units connected by suitable data network connections. Part of all of the software used to provide the optimization and protection toolset A40 may be stored in non-volatile storage A48, and/or in one or more computer readable media, and/or may be transmitted over a data network to the computer apparatus A42.

Note that the item of software A12 to be optimized and protected may also be a component for use in with or by another item of software such as an application. To this end, the item of software A12 could be, for example, a library, a module, an agent or similar.

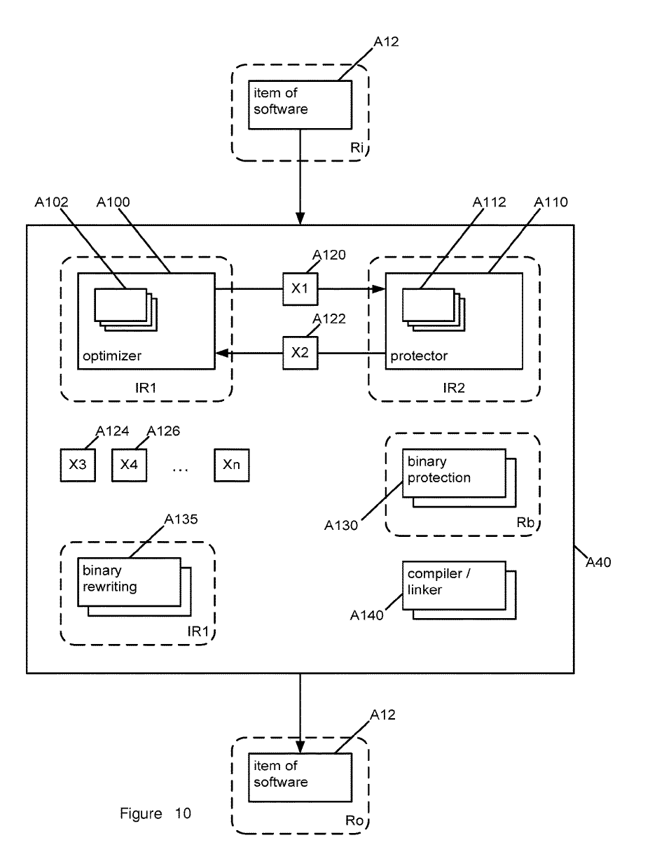

An exemplary implementation of the optimization and protection toolset A40 is shown schematically in FIG. 10. The optimization and protection toolset A40 includes an optimizer component A100 and a protector component A110. The optimizer component A100 is adapted to implement optimization techniques on the item of software A12. The optimizer component A100 is configured to implement such techniques in a first intermediate representation IR1, so that the item of software A12 needs to be rendered into this first intermediate representation IR1 before the optimizer component A100 carries out optimization of the item of software. The protector component A110 is adapted to implement protection techniques on the item of software A12. The protection component is configured to implement such techniques in a second intermediate representation IR2, so that the item of software A12 needs to be rendered into this second intermediate representation before the protector component A110 carries out protection of the item of software A12. The first and second intermediate representations are different representations to each other. Typically, the protector component A110 is not able to operate on the item of software when in the first intermediate representation, and the optimizer component is not able to operate on the item of software when in the second intermediate representation.

Each of the optimizer component A100 and protection component A110 may be implemented as a plurality of subcomponents A102, A112 in the optimization and protection toolset A40. The subcomponents of a particular component may provide different and/or replicated functionality with respect to each other, for example such that the overall role of a component may be distributed in various ways within the software of the optimization and protection toolset A40.

The optimization and protection toolset A40 also provides a plurality of converters which are adapted to convert an item of software A12 from one representation to another. These converters include a first converter component A120 arranged to convert an item of software from the first intermediate representation IR1 used by the optimizer component A100 to the second intermediate representation IR2 used by the protector component A110, and a second converter component A122 arranged to convert an item of software from the second intermediate representation IR2 used by the protector component A100 to the first intermediate representation IR1 used by the optimizer component 110. Of course, the first and second converter components A120, A122 may be combined in a single function software unit such as a single module, executable or object oriented method if desired.

The item of software A12 is provided to the optimization and protection toolset 40 in an input representation Ri. This input representation may be one of any of a number of different representations, for example either the first or second intermediate representations IR1, IR2, or another representation such as a source code representation, a binary code representation, and so forth. Similarly, item of software A12 is output from the optimization and protection toolset 40 in an output representation Ro. This output representation may also be one of any number of different representations, for example either of the first or second intermediate representations IR1, IR2, or another representation such as a source code representation, a binary code representation, and so forth.

The optimization and protection toolset A40 may also include one or more further components, each arranged to operate on the item of software A12 in a particular representation. Such components may for example include a binary protection component A130 providing binary protection tools arranged to operate on the item of software A12 in a binary representation Rb, a binary rewriting protection component A135 providing binary rewriting protection tools arranged to operate on the item of software A12 in a binary representation or some other representation such as the first intermediate representation, and so forth.

In addition to the first converter component A120 and the second converter component A122, the optimization and protection toolset A40 is therefore also provided with other converter components A124, A126 also shown in FIG. 10 as X3 . . . Xn, which are used for converting the item of software A12 between various representations as required. By way of example, one such converter component A124, A126 may convert from a C/C++ source code representation to the second intermediate representation IR2, and another such converter component may convert from the second intermediate representation IR2 back to the C/C++ source code representation.

FIG. 10 also shows, as part of the optimization and protection toolset A40 one or more compiler or compiler and linker components A140 that can be used to compile and link the item of software A12 for example to convert the item of software A12 typically into a native or binary code representation, or another suitable target representation.

Examples of source code representations which could be used for the input representation Ri, and other representations within the optimization and protection toolset A40, include C, C++, Objective-C, C#, Java, JavaScript, Ada, Fortran, ActionScript, GLSL, Haskell, Julia, Python, Ruby, and Rust, although the skilled person will be aware of many others. The input representation Ri may instead be a native or binary code, a byte code and so forth, or possibly one of the first and second intermediate representations.

Examples of representations which could be used for the output representation Ro include native code representations for direct execution on a user device, including native code representations such as PNaCl and NaCl which are adapted for execution under the control of a web browser, byte code representations such as Java byte code, representations adapted for interpreted execution or run time compiling such as Java source code, script representations such as JavaScript and subsets of JavaScript such as asm.js, and possibly the first or second intermediate representations.

The first intermediate representation IR1 may typically be selected as an intermediate representation convenient for, adapted or otherwise selected for carrying out optimization techniques. In particular, the first intermediate representation may be LLVM IR (LLVM Intermediate Representation). The LLVM project, which is known to the skilled person and discussed for example at the LLVM website “http://llvm.org”, provides a collection of modular and reusable compiler and tool-chain technologies that:

(i) introduce a well specified general purpose intermediate representation (LLVM IR) that supports a language-independent instruction set and type system;

(ii) provide the middle layers of a complete compiler system and infrastructure that take an item of software in LLVM IR and emit a highly optimised version of the item of software in LLVM IR ready for compile-time, link-time, run-time and “idle-time” optimization of programs written in a wide range of source code representations;

(iii) support rich LLVM front-end tools for source code and other representations that include not only C and C++, but also other popular programming languages such as the source code languages mentioned above, as well as Java byte-code etc.;

(iv) by a set of LLVM back-end tools, supports many other popular platforms and systems at present, and will support more mobile platforms in the near future; and

(v) work with OpenGL and low-end and high-end GPUs.

Other representations suitable for use as the first intermediate representation include Microsoft Common Intermediate Language (CIL). The second intermediate representation IR2 may typically be selected as an intermediate representation convenient for, adapted or otherwise selected for carrying out protection techniques. The second intermediate representation may, for example be designed and implemented in such a manner that source code in particular languages, for example C and C++, can be readily translated into the second intermediate representation, and such that the source code in the same or similar languages can be readily constructed from the second intermediate representation.

Optimization techniques carried out by the optimizer may include techniques to increase the speed of execution of the item of software, to reduce execution idle time, reduce the memory required for storage and/or execution of the item of software, increase usage of the core or GPU, and similar. These and other optimization functions are conveniently provided by the LLVM project. Techniques to achieve such optimizations may include vectorization, idle time, constant propagation, dead assignment elimination, inline expansion, reachability analysis, protection break normal and other optimizations.

The aim of the protector component is to protect the functionality or data processing of the item of software and/or to protect data used or processed by the item of software. This can be achieved by applying cloaking techniques such as homomorphic data transformation, control flow transformation, white box cryptography, key hiding, program interlocking and boundary blending.

In particular, the item of software after processing by the protector component will provide the same functionality or data processing as before such processing—however, this functionality or data processing is typically implemented in the protected item of software in a manner such that an operator of a user device cannot access or use this functionality or data processing from item of software in an unintended or unauthorised manner (whereas if the user device were provided with the item of software in an unprotected form, then the operator of the user device might have been able to access or use the functionality or data processing in an unintended or unauthorised manner). Similarly, the item of software, after processing by the protector component, may store secret information (such as a cryptographic key) in a protected or obfuscated manner to thereby make it more difficult (if not impossible) for an attacker to deduce or access that secret information (whereas if a user device were provided with the item of software in an unprotected form, then the operator of the user device might have been able to deduce or access that secret information).

For example:
The item of software may comprise a decision (or a decision block or a branch point) that is based, at least in part, on one or more items of data to be processed by the item of software. If the item of software were provided to a user device A20 in an unprotected form, then an attacker may be able to force the item of software to execute so that a path of execution is followed after processing the decision even though that path of execution were not meant to have been followed. For example, the decision may comprise testing whether a program variable B is TRUE or FALSE, and the item of software may be arranged so that, if the decision identifies that B is TRUE then execution path P_{T} is followed/executed whereas if the decision identifies that B is FALSE then execution path P_{F} is followed/executed. In this case, the attacker could (for example by using a debugger) force the item of software to follow path P_{F} if the decision identified that B is TRUE and/or force the item of software to follow path P_{T} if the decision identified that B is FALSE. Therefore, in some examples, the protector component A110 aims to prevent (or at least make it more difficult) for the attacker to do this by applying one or more software protection techniques to the decision within the item of software.
The item of software may comprise one or more of a security-related function; an access-control function; a cryptographic function; and a rights-management function. Such functions often involve the use of secret data, such as one or more cryptographic keys. The processing may involve using and/or operating on or with one or more cryptographic keys. If an attacker were able to identify or determine the secret data, then a security breach has occurred and control or management of data (such as audio and/or video content) that is protected by the secret data may be circumvented. Therefore, in some examples, the protector component A110 aims to prevent (or at least make it more difficult) for the attacker to identify or determine the one or more pieces of secret data by applying one or more software protection techniques to such functions within the item of software.

A “white-box” environment is an execution environment for an item of software in which an attacker of the item of software is assumed to have full access to, and visibility of, the data being operated on (including intermediate values), memory contents and execution/process flow of the item of software. Moreover, in the white-box environment, the attacker is assumed to be able to modify the data being operated on, the memory contents and the execution/process flow of the item of software, for example by using a debugger—in this way, the attacker can experiment on, and try to manipulate the operation of, the item of software, with the aim of circumventing initially intended functionality and/or identifying secret information and/or for other purposes. Indeed, one may even assume that the attacker is aware of the underlying algorithm being performed by the item of software. However, the item of software may need to use secret information (e.g. one or more cryptographic keys), where this information needs to remain hidden from the attacker. Similarly, it would be desirable to prevent the attacker from modifying the execution/control flow of the item of software, for example preventing the attacker forcing the item of software to take one execution path after a decision block instead of a legitimate execution path. There are numerous techniques, referred to herein as “white-box obfuscation techniques”, for transforming the item of software so that it is resistant to white-box attacks. Examples of such white-box obfuscation techniques can be found, in Examples of such white-box obfuscation techniques can be found, in “White-Box Cryptography and an AES Implementation”, S. Chow et al, Selected Areas in Cryptography, 9^{th} Annual International Workshop, SAC 2002, Lecture Notes in Computer Science 2595 (2003), p 250-270 and “A White-box DES Implementation for DRM Applications”, S. Chow et al, Digital Rights Management, ACM CCS-9 Workshop, DRM 2002, Lecture Notes in Computer Science 2696 (2003), p 1-15, the entire disclosures of which are incorporated herein by reference. Additional examples can be found in U.S. 61/055,694 and WO2009/140774, the entire disclosures of which are incorporated herein by reference. Some white-box obfuscation techniques implement data flow obfuscation—see, for example, U.S. Pat. No. 7,350,085, U.S. Pat. No. 7,397,916, U.S. Pat. No. 6,594,761 and U.S. Pat. No. 6,842,862, the entire disclosures of which are incorporated herein by reference. Some white-box obfuscation techniques implement control flow obfuscation—see, for example, U.S. Pat. No. 6,779,114, U.S. Pat. No. 6,594,761 and U.S. Pat. No. 6,842,862 the entire disclosures of which are incorporated herein by. However, it will be appreciated that other white-box obfuscation techniques exist and that examples of the may use any white-box obfuscation techniques.

As another example, it is possible that the item of software may be intended to be provided (or distributed) to, and used by, a particular user device A20 (or a particular set of user devices A20) and that it is, therefore, desirable to “lock” the item of software to the particular user device(s) A20, i.e. to prevent the item of software from executing on another user device A20. Consequently, there are numerous techniques, referred to herein as “node-locking” protection techniques, for transforming the item of software so that the protected item of software can execute on (or be executed by) one or more predetermined/specific user devices A20 but will not execute on other user devices. Examples of such node-locking techniques can be found in WO2012/126077, the entire disclosure of which are incorporated herein by reference. However, it will be appreciated that other node-locking techniques exist and that examples may use any node-locking techniques.

Digital watermarking is a well-known technology. In particular, digital watermarking involves modifying an initial digital object to produce a watermarked digital object. The modifications are made so as to embed or hide particular data (referred to as payload data) into the initial digital object. The payload data may, for example, comprise data identifying ownership rights or other rights information for the digital object. The payload data may identify the (intended) recipient of the watermarked digital object, in which case the payload data is referred to as a digital fingerprint—such digital watermarking can be used to help trace the origin of unauthorised copies of the digital object. Digital watermarking can be applied to items of software. Examples of such software watermarking techniques can be found in U.S. Pat. No. 7,395,433, the entire disclosure of which are incorporated herein by reference. However, it will be appreciated that other software watermarking techniques exist and that examples may use any software watermarking techniques.

It may be desirable to provide different versions of the item of software to different user devices A20. The different versions of the item of software provide the different user devices A20 with the same functionality—however, the different versions of the protected item of software are programmed or implemented differently. This helps limit the impact of an attacker successfully attacking the protected item of software. In particular, if an attacker successfully attacks his version of the protected item of software, then that attack (or data, such as cryptographic keys, discovered or accessed by that attack) may not be suitable for use with different versions of the protected item of software. Consequently, there are numerous techniques, referred to herein as “diversity” techniques, for transforming the item of software so that different, protected versions of the item of software are generated (i.e. so that “diversity” is introduced). Examples of such diversity techniques can be found in WO2011/120123, the entire disclosure of which are incorporated herein by reference. However, it will be appreciated that other diversity techniques exist and that examples may use any diversity techniques.

The above-mentioned white-box obfuscation techniques, node-locking techniques, software watermarking techniques and diversity techniques are examples of software protection techniques. It will be appreciated that there are other methods of applying protection to an item of software. Thus, the term “software protection techniques” as used herein shall be taken to mean any method of applying protection to an item of software (with the aim of thwarting attacks by an attacker, or at least making it more difficult for an attacker to be successful with his attacks), such as any one of the above-mentioned white-box obfuscation techniques and/or any one of the above-mentioned node-locking techniques and/or any one of the above-mentioned software watermarking techniques and/or any one of the above-mentioned diversity techniques.

There are numerous ways in which the protector component A110 may implement the above-mentioned software protection techniques within the item of software A260. For example, to protect the item of software, the protector module A110 may modify one or more portions of code within the item of software and/or may add or introduce one or more new portions of code into the item of software A220. The actual way in which these modifications are made or the actual way in which the new portions of code are written can, of course, vary—there are, after all, numerous ways of writing software to achieve the same functionality.

The binary protection component A130 is for accepting the software item in the form of native or binary code or byte code after compiling by the compiler and linker A140, and applies binary protection techniques such as integrity verification, anti-debugging, code encryption, secured loading, and secured storage. The binary protection component then typically repackages the item of software into a fully protected binary with necessary security data that can be accessed and used during its loading and execution on user devices A20.

Thus, for an item of software in which a developer can access all source code, the optimization and protection toolset A40 can be used to apply source code protection tools to the source code of the application first in the second intermediate representation, using the protection component A112, and then to apply binary protection to the binary that is already protected by using source code protection techniques. Applying such protection to an item of software in both source code and binary code domains results in a more effectively protected item of software.

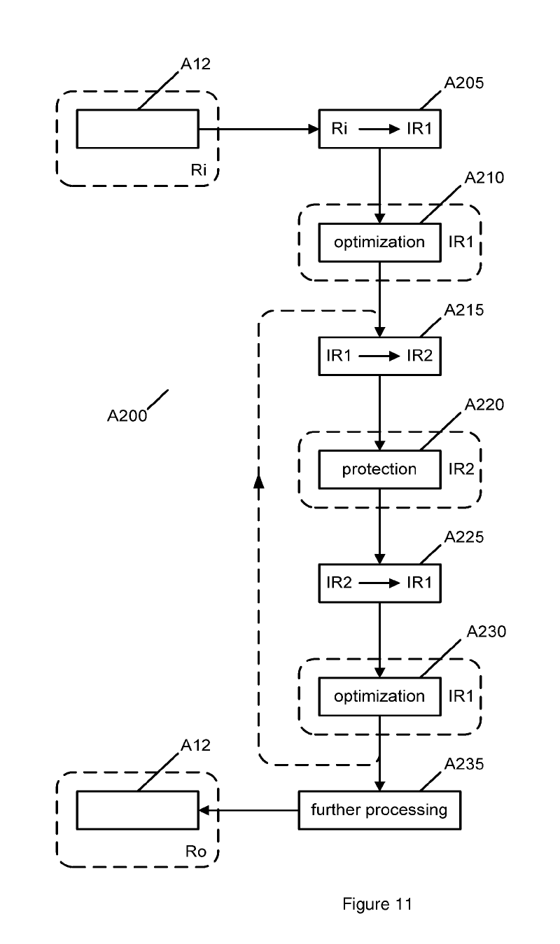

FIG. 11 illustrates some of the work flows A200 which may be implemented using the optimization and protection toolset A40. An item of software is provided to the toolset in an input representation Ri. This representation might typically be a source code or binary code representation as discussed above. The item of software is converted to the first intermediate representation at step A205. This might involve using a single converter component A120-A128, or two or more converter components. Typically, the item of software might be converted from the input representation Ri directly into the first intermediate representation, or from the input representation Ri into the first intermediate representation via another representation such as the second intermediate representation.

The item of software in the first intermediate representation IR1 is then optimized at step A210 using the optimizer component A100 of FIG. 10, and then converted to the second intermediate representation IR2 at step A215, using the first converter A120 of FIG. 2. The item of software in the second intermediate representation IR2 is then protected at step A220 using the protector component A110 of FIG. 10, and then converted back to the first intermediate representation IR1 at step A225 using the second converter A122 of FIG. 10.

The item of software in the first intermediate representation IR1 is then optimized again at step A230 using the optimizer component A100 of FIG. 10. It may then be subject to various aspects of further processing at step A235 before being output in the output representation Ro. Aspects of further processing may include one or more of compiling and linking, binary protection, conversion to other representations and so forth.

A broken flow arrow in the figure indicates that after the second optimization step A230, the work flow A200 may return to steps A215 for conversion back to the second intermediate representation, and one or more further steps of protection and optimization.

The work flow A200 of FIG. 11 can be varied in different ways. For example, the item of software may be optimized just once, either before or after the step of protection A220, and the step of further processing A235 may be omitted or include multiple steps. Either protection or optimization may be carried out before the other, and any number of further steps of optimization and protection may be carried out. Conversion from the input representation Ri to the representation used for optimization IR1 may include multiple conversion steps for example a conversion from Ri to IR2 followed by a conversion from IR2 to IR1. The further processing step A235 may include other optimization and/or protection steps, for example a binary rewriting protection step.

More specific examples of how the optimization and protection toolset A40 of FIG. 10 and the work flows such as those of FIG. 11 may be implemented will now be described. In these particular examples, the first intermediate representation is typically the LLVM IR discussed above. This enables expansion of the scope of native application protection for better performance and security, and also to open up new security possibilities for much larger scope of operation of the optimization and protection toolset A40.

It has become apparent to the inventors that there are conflicting issues between security and performance in preparing an item of software for distribution to a plurality of user devices A20. In general, protected software introduces necessary redundancy and overhead that will slow down the performance of the software in the protected, and especially cloaked form. the more protection techniques that are applied to the item of software, the more significant is the impact on performance. Therefore, performance and security need to be balanced.

Typical protection techniques may transform static program dependencies into partially static and partially dynamic dependencies. This prevents completely static attacks that are usually much easier to carry out than dynamic attacks. However, it also introduces a limitation that these protection techniques can break certain optimization capabilities which rely on analysis of properties of static dependencies. Because of this limitation, protection and optimization strategies need to make choice between less security/protection but better optimization for example in terms of execution speed and/or smaller program size, and more security/protection but less optimization.

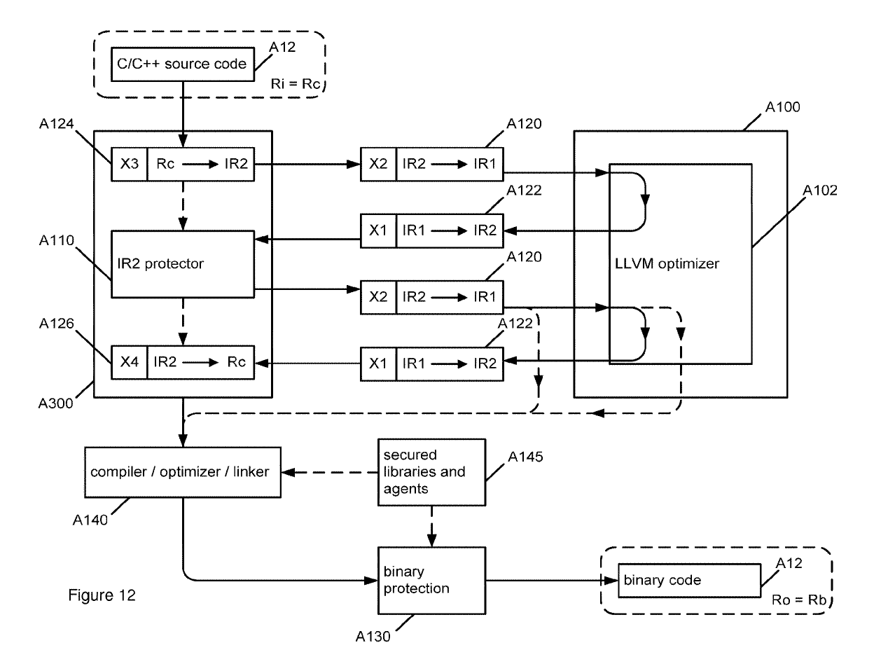

FIG. 12 illustrates a work flow which can be implemented using the optimization and protection toolset A40. The item of software is provided to the optimization and protection toolset A40 in an input representation Ri which is a C/C++ source code representation Rc. This is passed to a toolset component grouping A300 which consists of a converter X3 from representation Rc to the second intermediate representation IR2, the protector component A110, and a converter X4 from the second intermediate representation IR2 back to the source code representation Rc. If no LLVM optimization in the first intermediate representation is to take place, then the item of software can be passed through each of these functions sequentially to protect the item of software before being passed to the compiler, optimizer and linker A140, and then on to binary protection component A130 to output the item of software in an output representation which is a native/binary code representation Rb. A set of secure libraries and agents A145 is also provided for use in compiling/linking the item of software 1A2, and if required for use by the binary protection component A130.

The toolset component grouping A300 is complemented by the optimizer component A100, shown here for the purposes of clarity as a single subcomponent A102 implementing one or more LLVM optimization tools, although multiple subcomponents A102 could be used for example with a different subcomponent, multiple subcomponents, or different combinations of subcomponents being used at each stage of optimization. The X1 and X2 converters of FIG. 10 are then used to convert the item of software from the second intermediate representation formed using the X3 converter 124 and/or as output by the protector component A112 in the toolset component grouping A300, to the first intermediate representation for use by the LLVM optimization tools, and to convert the item of software following optimization by the LLVM optimization tools for protection by the protector component A110 and/or for conversion by the X4 converter back to the Rc representation.

Some alternative work flow pathways are illustrated in FIG. 12 using broken lines. For example, following processing by protector component A110 and conversion to the IR1 representation, the item of software can be sent directly to the compiler, optimizer and linker A140 without a second step of processing by the optimizer component A100. Similarly, after a second step of processing by the optimizer component A100, the item of software can be sent directly to the compiler, optimizer and linker A140 without conversion by the X1 and X4 converters, if the compiler, optimizer and linker A140 is able to handle input in the first intermediate representation.

The X1 and X2 converters therefore provide a bridge between the domain of the protection techniques provided by the protector component in the second intermediate representation, and the domain of the optimization techniques provided by the LLVM optimization tools in the first intermediate representation, thereby integrating these two areas of operation of the optimization and protection toolset A40. This approach also helps to resolve the conflict between protection and optimization discussed above, because the optimization and protection toolset A40 can leverage the power of the available LLVM optimization tools and techniques, to provide optimization both before and after the protection techniques are applied by the protection component A110. By enabling optimization at multiple levels, it is possible to remove the limitation between security and performance so that both better security and improved performance can both be achieved for the same item of software A12.

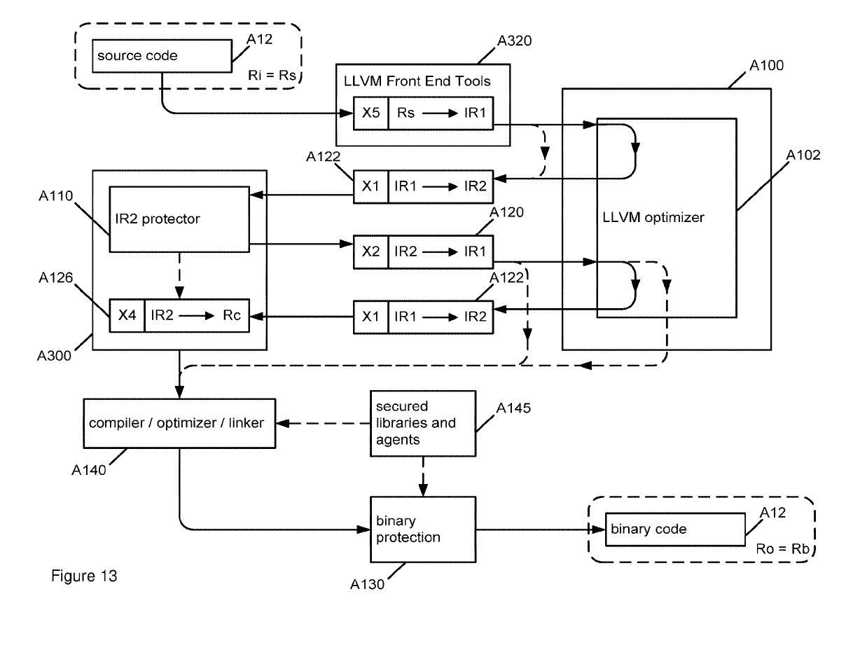

FIG. 13 illustrates another work flow which can be implemented using the optimization and protection toolset A40. In this figure, the item of software is provided to the optimization and protection toolset 40 in an input representation Ri which is a source code representation Rs. The source code representation Rs could be, for example, Objective-C, Java, JavaScript, C#, Ada, Fortran, ActionScript, GLSL, Haskell, Julia, Python, Ruby or Rust. The item of software is passed to a converter X5 which converts the source code representation Rs into the first intermediate representation. The converter X5 may be provided as part of a set of LLVM front-end tools A320 providing conversion to LLVM IR from a wide variety of source code representations. The item of software now in LLVM IR can be passed to the optimizer component A100 for a first step of optimization by the LLVM optimizer tools, or directly to the X1 converter (as shown by a broken line) for conversion to the second intermediate representation before being passed to the protector component A110. The remaining parts of FIG. 13 correspond to FIG. 12. Note that the toolset component grouping 300 of FIG. 13 is not shown as including the X3 converter because it is not necessary in the work flow of FIG. 13, but it could nonetheless be included in this grouping if desired.

Since the very rich set of available LLVM front-end tools A320 can convert many different languages into LLVM IR, and thereby leverage LLVM compilation facilities to obtain sophisticated analysis and better performance, these LLVM front-end tools can be used, as illustrated in FIG. 13, to extend the front-end capabilities of the optimization and protection toolset A40 to convert program source code in a large set of programming languages into the second intermediate representation via the first intermediate representation where the protection techniques of the protector component A110 can be applied.

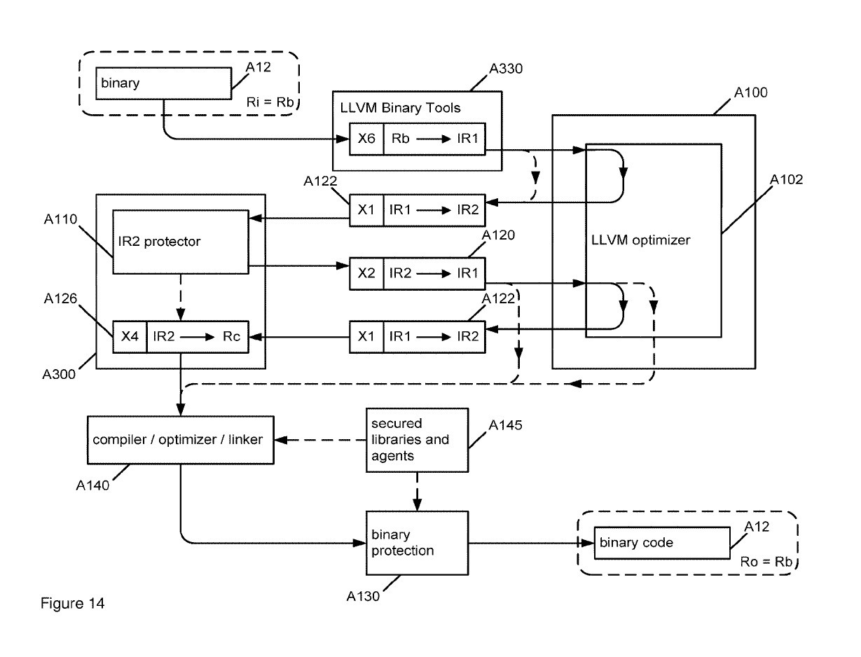

FIG. 14 illustrates another work flow which can be implemented using the optimization and protection toolset A40. In this figure, the item of software is provided to the optimization and protection toolset A40 in an input representation Ri which is a native/binary representation Rb, for execution on particular platform or class of user device A20. The binary representation Rb could be, for example, any of x86, x86-64, ARM, SPARC, PowerPC, MIPS, and m68k binary representations. The item of software is passed to a converter X6 which converts the binary representation Rb into the first intermediate representation. The converter X6 may be provided as part of a set of LLVM binary tools A330 providing conversion to LLVM IR from a wide variety of binary representations. The remaining parts of FIG. 14 correspond to FIGS. 12 and 13.

By using LLVM binary tools in this way, an item of software in native/binary code can be converted into LLVM IR form, before being converted in the second intermediate representation for input into the protector component A300 for protection techniques such as cloaking to be applied. If the output representation Ro is a binary code for a different target platform than that of the input representation binary code, the optimization and protection toolset A40 can easily be used to reach this goal of an output for a different target platform at the same time as applying the required protection techniques, by suitable configuration of the complier, optimizer and linker A140.

LLVM compiler middle layer tools include sophisticated program analysis capabilities, such as more precise alias analysis, pointer escape analysis, and dependence analysis, that can provide rich program properties and dependencies that can be used to transform programs for different purposes. The binary rewriting protection component A135 illustrated in FIG. 10 provides one or more binary rewriting protection tools which accept an item of software in LLVM IR form, make obfuscating transformations by leveraging LLVM's program analysis functionalities, and results in a more secure version of the item of software in the LLVM IR. The binary rewriting protection component A135 can enhance protection of the item of software in a number of different ways, including stand-alone binary rewriting protection, binary rewriting protection with binary protection tools, and binary rewriting protection with both source cloaking tools and binary protection tools:

Stand-Alone Binary Rewriting Protection—

generally, binary protection protects binary code in binary forms, and some such protection techniques need to work on binary representations, for example integrity verification, secure loading, and dynamic code encryption. Also, binary protection can apply certain kinds of transformations if required program information becomes available. However, existing binary protection tools tend to have limited support of analysis capacity such that very limited binary transformations can be done directly in binary form. Instead, a binary rewriting protection tool can be adapted to act on an item of software in an intermediate representation such as LLVM IR, in which much more sophisticated program analysis supports can be leveraged, thereby applying many transformation techniques that cannot be easily applied directly to software in a binary representation.

In a stand-alone mode, an item of software in an unprotected binary code representation is translated into the LLVM IR using one or more LLVM binary tools A330, and then the binary rewriting protection component A135 is used to apply certain program transformations to the item of software by interacting with LLVM program analysis tools. The rewritten item of software in LLVM IR is then translated into a protected binary code representation by using an LLVM IR to binary converter, a compiler, optimizer and linker, or in other ways.

Binary Rewriting Protection with Binary Protection Tools—

in this mode, an item of software provided to the optimization and protection toolset A40 in a binary code representation can be obfuscated into a protected binary representation by using the binary rewriting protection component A135. The item of software can then be further protected by using general binary protection tools such as provided by binary protection component A130 of FIG. 10. Combining different layers of protection together in this way by using both binary rewriting protection and binary protection leads to a more secure item of software A12.

Binary Rewriting Protection with Both Source Level Protection and Binary Protection—

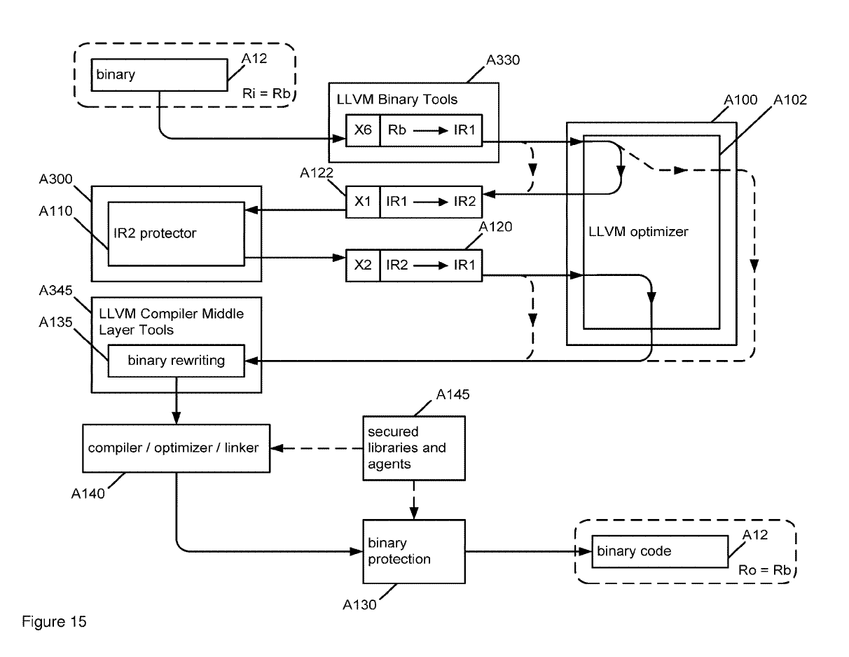

in general, protection processing of source code type representations such as the second intermediate representation discussed above can provide more comprehensive and deeper data flow and control flow protection. FIG. 15 illustrates this using a work flow similar to that of FIG. 14 in which LLVM binary tools are used to convert an item of software A12, provided to the optimization and protection toolset A40 in a binary representation, to the first intermediate representation. Additionally in FIG. 15, the item of software output from the optimizer component A102, or alternatively directly from converter X2, after action of the protector component A112, is directed to the binary rewriting protection tool A135. After operation of the binary rewriting protection tool A135 the item of software is then passed on to the compiler, optimizer and linker A140 as previously described. The binary rewriting protection tool A135 is an example of an LLVM compiler middle layer tool A345 which can be used in this arrangement. As shown by broken lines in FIG. 15, the item of software may instead be directed straight to the binary rewriting protection tool after the first optimization without processing by the protector component A112 or a second stage of optimization, or may be processed in a manner which omits either the first or second steps of optimization.

A web application is an application that uses a web browser as a client environment. A web application is typically coded in a browser-supported programming language such as JavaScript, combined with a browser-rendered markup language such as HTML, and depends on its host web browser to render it executable. “asm.js” is a restricted subset of JavaScript, discussed for example at the website http://asmjs.org. “asm.js” supports C-like computations, but because it is a subset of JavaScript it runs correctly in any web browser supporting JavaScript, not requiring any further special support. The subset used by asm.js makes it easy to recognize low-level operations using trivial methods of type inference. “asm.js” does depend on the extensions needed to support WebGL (buffers and type arrays such as Ulnt32, INt 16 and so forth) in order to support low-level structures, arrays, etc., but these are usually available in the hosting web browser. That a JavaScript program conforms to the “asm.js” representation can be marked in the JavaScript file using the “use asm” directive. The hosting web browser can then ignore this directive is explicit support for “asm.js” is absent, or can check the program for compliance with the “asm.js” representation if support is available. If support is available in the web browser, then asm.js code can run at greatly increased speed and efficiency compared with usual JavaScript, typically through compilation of the asm.js code into a native binary code representation.

Tools are provided in the prior art for converting source code representations such as C and C++ into the asm.js representation. One such tool chain would consist of the Clang tool (see http://clang.llvm.org which converts C and C++ representations into the LLVR IR, and the Emscripten tool (see https://github.com/kripken/emscripten) which converts LLVM IR into the asm.js representation. LLVM optimization tools can be applied as part of this tool chain to effect optimization before application of the Emscripten tool.

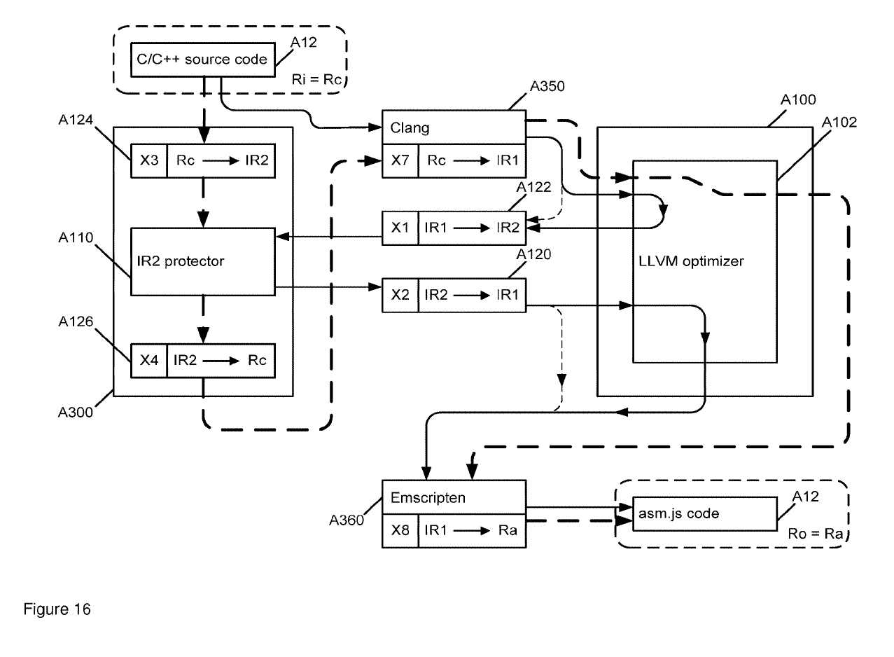

FIG. 16 illustrates how the optimization and protection toolset A40 can be used to optimize and protect an item of software provided in a C/C++ source representation Rc, and output the item of software in an asm.js representation Ra. The work flows of FIG. 16 follow similar schemes to those of FIGS. 12 to 15.

According to a first work flow route shown in heavy broken lines, the item of software input in the C/C++ representation Rc is passed to the toolset component grouping A300 where it is converted to the second intermediate representation by converter X3, then protected by protection component A112, and then converted back to the C/C++ representation Rc. The protected item of software is then passed to a Clang component A350 denoted as X7 which converts the C/++ source code representation Rc to the first intermediate representation IR1, typically LLVM IR. This representation is passed to the LLVM optimizer A310 forming part of the optimizer component A102, and then to an Emscripten component A360 denoted as X8 which converts the first intermediate representation to an asm.js representation Ra for output.

According to a second work flow route generally shown in solid lines, the item of software input in the C/C++ representation Rc is passed first to the Clang component A350 denoted as X7 which converts the C/++ source code representation Rc to the first intermediate representation IR1, typically LLVM IR. This representation is passed to the LLVM optimizer A310 forming part of the optimizer component A102, and then to the first converter A122 denoted as X1 for conversion to the second intermediate representation for passing to the protector component A112. After processing by the protector component A112 the item of software is passed to the second converter A120 denoted as X2 for conversion back to the first intermediate representation and then to the optimizer component A102 for a second stage of optimization. Finally, the item of software is passed to the Emscripten component A360 denoted as X8 which converts the first intermediate representation to an asm.js representation Ra for output. Some alternatives within this work flow are shown in light broken lines, by which either the first or second step of optimization can be omitted.

By using the optimization and protection toolset A40 to implement C/C++ to asm.js conversion including protection and optimization it is possible to both develop new items of software such as web apps in C/C++ for delivery to user devices in asm.js, and also to migrate existing items of software in C/C++ into protected and optimized asm.js representations. Because asm.js enabled browsers can perform much stronger run-time optimization than if general JavaScript is used, the optimized and protected asm.js item of software can be run at high speed. Indeed, tests by the inventors have shown that items of software written in C/C++ and processed using the optimization and protection toolset A40 as discussed above to form optimized and protected asm.js code can perform better than a corresponding item of software originally written in native code. This indicates excellent performance of the optimizers used in the optimization and protection toolset A40.

Although FIG. 16 shows the use of the optimization and protection toolset A40 to accept an item of software input in C or C++, other source code representations such as Object-C, Java, JavaScript, C# and so forth can be used for the input representation Ri by using a different LLVM front end tool in place of the Clang tool A350 shown in FIG. 16, with subsequent steps of optimization and protection as already discussed and final conversion to the asm.js representation Ra. This opens up many new opportunities to migrate existing applications in languages other than C/C++ into web applications, or to develop new web applications in these languages that can be made available for use in browser environments.

Similarly, the work flows shown in FIG. 16 can be changed to accept an input item of software in a native/binary representation Rb by replacing the Clang tool A350 with one or more LLVM binary tools A330 (for example as already discussed in connection with FIG. 15). A significant advantage of such a work flow is that existing items of software in native code representations can be migrated into web apps for running in browser environments (for example HTML5) with the enhanced security provided by the protection component A112, while maintaining performance for example in terms of speed of execution.

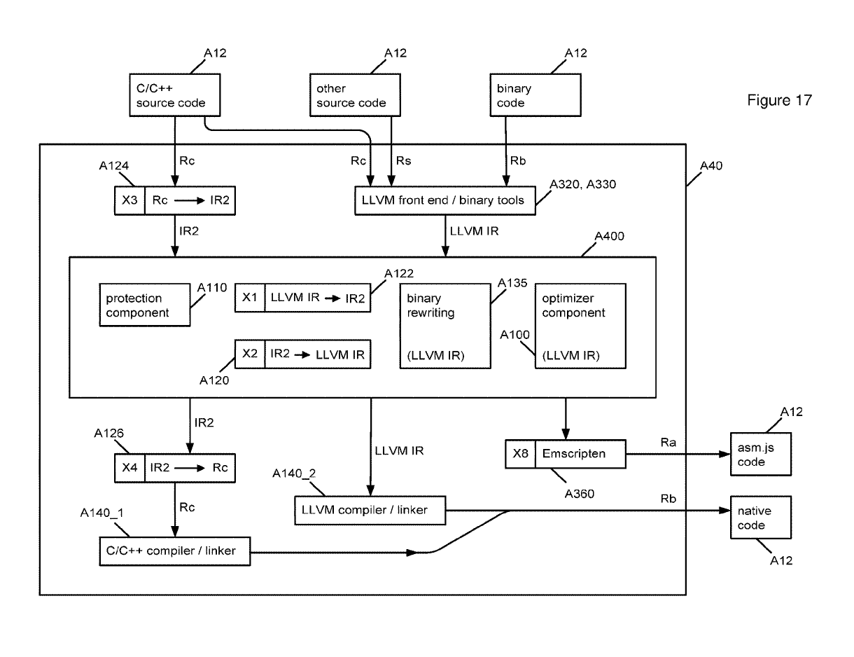

FIG. 17 illustrates again the optimization and protection toolset A40 already shown in FIG. 10, but now with some other specific detail and aspects reflecting the work flows discussed in connection with FIGS. 11-16. For example, the optimization and protection toolset A40 illustrated in FIG. 17 makes specific reference to use of LLVM IR as the first intermediate representation. Adopting a technology framework such as LLVM can help in applying software protection capabilities oriented towards or originally written for C/C++ source code structures and similar, to the protection of items of software provided in other source code representations, binary code representations and similar.

FIG. 17 therefore shows that an item of software for input to the optimization and protection toolset A40 can be in C/C++ source code (representation Rc), another source code (representation Rs) or a native/binary code (representation Rb). If the input item of software is in a C/C++ source code representation, then it can be converted to the second intermediate representation which is used by the protection component A112 using the X3 converter. All of the different representations of the input item of software can be converted to the first intermediate representation which is the LLVM IR using LLVM front end/binary tools A320,A330.

The input item of software can then be processed in various ways by elements of the unified toolset grouping A400. These components include the protection component A110 which operates on the item of software in the second intermediate representation, the binary rewriting protection component A135 which operates on the item of software in the LLVM intermediate representation, and the optimizer component A102 which operates on the item of software in the LLVM intermediate representation. The unified toolset grouping A400 also includes at least the first and second X1, X2 converters A122, A120 which convert between the LLVM intermediate representation and the second intermediate representation, so that any of the components of the unified toolset grouping A400 can act on the item of software A12.

After processing by the components of the unified toolset grouping A400, the item of software can be passed to various components for further processing in order to form the item of software in the relevant output representation. If passed from the unified toolset grouping A400 in the second intermediate representation the item of software can be converted back to the C/C++ source code representation Rc using converter X4 A126 for compiling and linking by C/C++ compiler and linker component A140-1. If passed from the unified toolset grouping A400 in the LLVM intermediate representation the item of software can be compiled and linked by the LLVM compiler and linker A140-2. In both cases the output from the optimization and protection toolset A40 is then the item of software in a native/binary code representation Rb. Alternatively, the item of software can be passed from the unified toolset grouping A400 in the LLVM intermediate representation to the converter X8 provided by the Emscripten tool A360 so that the output from the optimization and protection toolset A40 is then the item of software in the asm.js representation Ra.

Using the optimization and protection toolset A40 of FIG. 17, an item of software such as an application or software module or library, no matter what language has been used to implement it, can be protected using the same protection component A110 and the toolset of cloaking and other techniques which may be implemented by that component A110. If the item of software is output from the optimization and protection toolset A40 in native/binary code, this can be run in native execution environments (including PNaCl), or if output in JavaScript or asm.js, this can be run in web browser environments. This is achieved in the optimization and protection toolset A40 of FIG. 17 by operating the components of the unified toolset grouping A400 in two different intermediate representations, with the protection component A110 operating on the item of software in the second intermediate representation, and at least the optimizer component A100 operating on the item of software in the LLVM intermediate representation.

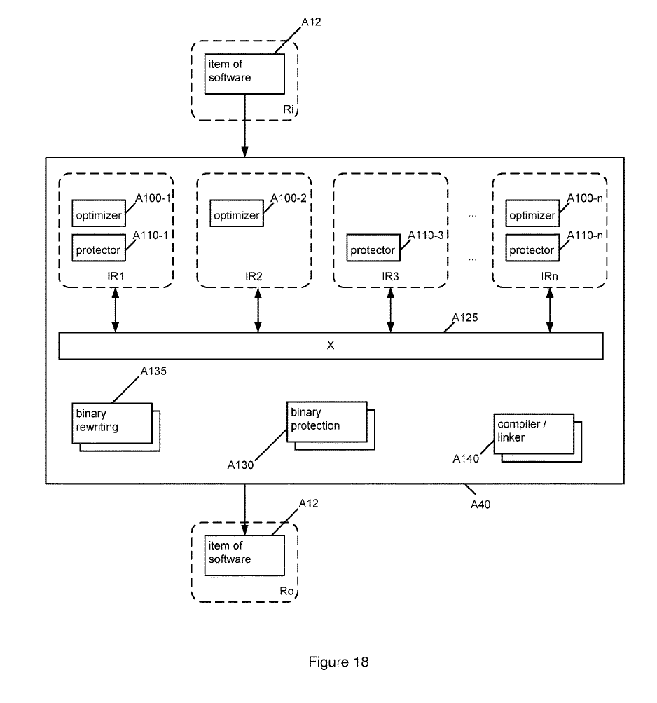

The arrangements illustrated in FIGS. 10-17 mostly make use of a first intermediate representation for carrying out optimization of an item of software, and a second intermediate representation for carrying out protection of the item of software. However, referring to FIG. 18, it is possible to use the first representation for carrying out protection of the item of software, and/or the second representation for carrying out optimization of the item of software. Additionally, although the arrangements of FIGS. 10-17 make use of two intermediate representations, it will be appreciated that it is possible to use of three of more intermediate representations, with each intermediate representation being used for one or both of optimization and protection of an item of software.

FIG. 18 is similar to FIG. 10, but shows how an arbitrary number of intermediate representations IR1 . . . IRN may be used by the optimization and protection toolset A40, with each intermediate representation being used for one or both of protection and optimization. For example, in the arrangement of FIG. 18 the first intermediate representation IR1 is used by both an optimizer component A100-1 and a protector component A110-1, the second intermediate representation is used by an optimizer component A100-2, but not by any protector component, and the third intermediate representation is used by a protector component A110-3 but not by any optimizer component. As for FIG. 10, each optimizer component may comprise one or more optimizer subcomponents (not shown in FIG. 18) and each protector component may comprise one or more protector subcomponents (also not shown in FIG. 18). These subcomponents may carry out any of the functions of optimization and protection as already discussed above, but within the confines of the appropriate intermediate representation.

Note that although FIG. 18 shows different protector and/or optimizer components for use with each different intermediate representation, it is also possible for one or more of the protector and/or optimizer components to work within multiple different ones of the intermediate representations. Although the components shown in FIG. 18 in respect of each intermediate representation are optimizer and/or protector components, components for carrying out other tasks and transformations on the item of software may be provided, for use in one or more of the intermediate representations.

The various intermediate representations IR1 . . . IRN may include LLVM IR, and various other representations for example as already discussed above. In order to convert the item of software, typically in various states of protection and/or optimization as the toolset is used, between the various intermediate representations IR1 . . . IRN, appropriate converter functionality A125 is provided. Converter functionality A125 may be implemented for example as a single library, class, tool or other element, or as multiple such elements with each such element carrying out one or more of the required conversion types. It is not always necessary for all possible conversions between the various intermediate representations to be provided, and similarly some conversions may be provided as combinations of two or more other conversions, for example through a more commonly used intermediate representation such as LLVM IR.

Also shown in FIG. 18 as part of the optimization and protection toolset A40 are one or more binary rewriting tools A135, one or more binary protection tools A130, and one or more compiler and/or linker tools A140. Each of these may operate using one or more of the intermediate representations IR1 . . . IRN, or other representations, according to the requirements of the toolset A40.

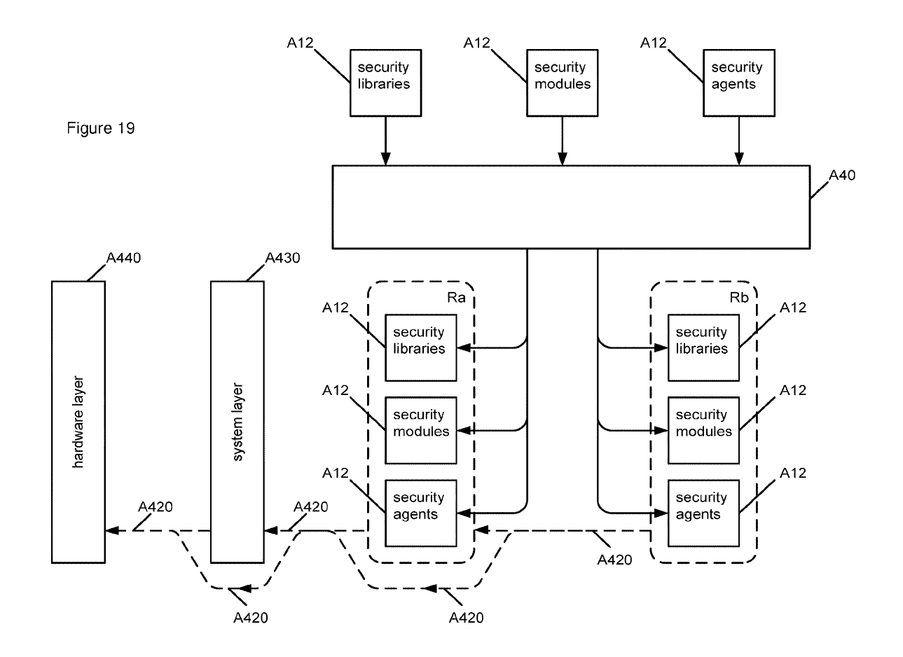

The optimization and protection toolset A40 discussed above and illustrated in FIGS. 10 and 17 can be used to protect software components such as libraries, modules and agents, as well as applications, and all such software components fall within the scope of the described items of software A12. This is illustrated in FIG. 19 in which various items of software which may be security libraries, modules, agents and similar are input to the optimization and protection toolset A40, which outputs these items of software in protected and optimized forms. Any such item of software may be output in a native/binary code representation Rb and/or an asm.js representation Ra according to requirements. The arrows A420 connecting one or more of the optimized and protected items of software in the asm.js representation with one or more of the optimized and protected items of software in the native/binary code representation, and each of these with an underlying system layer A430 and a further underlying hardware layer A440, represent that each of the asm.js, native and system layers can access and use features such as security features of each lower level in the hierarchy.

In general, software components such as security libraries, modules and agents have their own security capabilities and features, and robustness and security of these software components may be critical in ensuring the security of applications within which they are used or by which they are referenced or called. The optimization and protection toolset A40 and work flows described herein can therefore be used to improve the security of such software components, and therefore also applications within which such components are used.

Using aspects of the described arrangements, a user device A20 can be provided with multiple layers of security including hardware level security features, system or operating system level security features, native layer security features and web layer security features. Software components such as libraries, modules and agents protected using the optimization and protection toolset A40 can provide access to hardware and system level security features which should not be made visible to the web application layer. Since the optimization and protection toolset A40 can be used to create protected software components in both native code and JavaScript (including asm.js), it can be used to construct and support invoking dependencies from protected software components in JavaScript/asm.js to protected software components in native code.

1. An electronics device comprising one or more modules that implement a security-related operation in an obfuscated manner to thereby provide the security-related operation with resistance against a hardware attack, wherein the electronics device is either (a) a printed electronics device or (b) a device created using e-beam lithography.

2. The electronics device of claim 1, wherein the security-related operation uses secret data and wherein the implementation of the security-related operation by the one or more modules protects the secret data against the hardware attack.

3. The electronics device of any one of the preceding claims, wherein the security-related operation comprises one or more of:
(i) a cryptographic operation;
(ii) a conditional access operation;
(iii) a digital rights management operation;
(iv) a key management operation.

4. The electronics device of claim 3, wherein the cryptographic operation comprises one or more of: an encryption operation; a decryption operation; a digital signature generation operation; a digital signature verification operation; a hash generation operation; a hash verification operation.

5. The electronics device of any one of the preceding claims, wherein the security-related operation processes input data in order to generate output data, and wherein the one or more modules implement the security-related operation in an obfuscated manner, at least in part, by being arranged to receive a transformed version of the input data and by being arranged to process the transformed version of the input data to generate a transformed version of the output data.

6. The electronics device of any one of the preceding claims, comprising one or more inputs for receiving input data, wherein the implementation of the security-related operation by the one or more modules is arranged to use data provided by the one or more inputs.

7. The electronics device of claim 6, when dependent on claim 5, wherein at least one of the one or more inputs is arranged to form a transformed version of input data that the at least one of the one or more inputs receives and to provide the transformed version of input data to the one or more modules.

8. The electronics device of any one of the preceding claims, comprising one or more outputs for outputting data, wherein the implementation of the security-related operation by the one or more modules is arranged to generate processed data and to output provide the processed data to at least one of the one or more outputs.

9. The electronics device of claim 8, when dependent on claim 5, wherein the processed data comprises a transformed version of output data and the at least one of the one or more outputs is arranged to obtain the output data from the transformed version of output data.

10. The electronics device of any one of the preceding claims, comprising one or more sensors, wherein the implementation of the security-related operation by the one or more modules is arranged to use data generated by the one or more sensors.

11. The electronics device of claim 10, when dependent on claim 5, wherein at least one of the one or more sensors is arranged to form a transformed version of input data that the at least one of the one or more sensors generates and to provide the transformed version of input data to the one or more modules.

12. The electronics device of any one of the preceding claims, comprising one or more modules that implement at least one of:
(i) an integrity verification operation;
(ii) a tamper detection operation;
(iii) detection of an attack being performed against the electronics device;
(iv) an operation to verify one or more predetermined properties of an object to which the electronics device is connected;
(v) an operation to verify that the electronics device is connected to an object.

13. An apparatus comprising an electronics device according to any one of the preceding claims.

14. The apparatus of claim 13, wherein the apparatus is an identification label for attachment to an article, and wherein:
the security-related operation comprises:
storing an identification code for identifying the article; and
in response to receiving a request, generating a message that comprises the identification code; and
the apparatus comprises an interface arranged to:
provide the request to the electronics device;
receive the message from the electronics device; and
output the message.

15. The apparatus of claim 14, wherein:
the request comprises a nonce; and
the security-related operation comprises performing a cryptographic operation based, at least in part, on the nonce and a secret key, wherein the implementation of the security-related operation by the one or more modules protects the secret key against the hardware attack, and wherein the message is based, at least in part, on a result of the cryptographic operation.

16. The apparatus of claim 15, wherein:
the electronics device comprises a sensor that is arranged to generate data; and
the secret key is based, at least in part, on the data generated by the sensor.

17. The apparatus of claim 16, wherein the sensor is arranged to generate data based on one or more predetermined properties of the article.

18. The apparatus of claim 13, wherein the apparatus is a smartcard.

19. A method of generating an electronics device, the electronics device being either (a) a printed electronics device or (b) a device created using e-beam lithography, the method comprising:
including, as part of the electronics device, one or more modules that implement a security-related operation in an obfuscated manner to thereby provide the security-related operation with resistance against a hardware attack.

20. The method of claim 19, comprising:
receiving code, written in a hardware description language, wherein the code represents functionality for the electronics device including the security-related operation;
applying one or more white-box protection techniques to the received code to form protected code that protects the security-related operation against the hardware attack; and
using the protected code to generate the electronics device.

21. The method of claim 20, wherein using the protected code comprises converting the protected code into a netlist for the electronics device and creating the electronics device based on the netlist.

22. The method of any one of claims 19 to 21, wherein the electronics device is an electronics device according to any one of claims 1 to 13.

23. An apparatus arranged to carry out a method according to any one of claims 19 to 22.

24. A computer program which, when executed by a processor, causes the processor to carry out a method according to any one of claims 19 to 22.

25. A computer-readable medium storing a computer program according to claim 24.

26. An apparatus comprising:
a camera;
a wireless communications interface; and
a processor configured to:
control the camera to capture an image;
receive a selection of a part of the image, the selected part representing a selected electronics device; and
control the wireless communications interface to establish a wireless data communications link with the selected electronics device.

27. The apparatus of claim 26, wherein the processor is arranged to control the wireless communications interface to establish the wireless data communications link with the selected electronics device by steering a radio-frequency beam generated by the wireless communications interface towards the selected electronics device.

28. The apparatus of claim 26, wherein the processor is arranged to control the wireless communications interface to establish a wireless data communications link with the selected electronics device by:
detecting one or more candidate electronics devices; and
for one or more of the one or more candidate electronics devices:
sending a request to one of the candidate electronics devices to request a visual signal from the candidate electronics device;
using the camera to detect the visual signal;
determining whether the detected visual signal corresponds to the selected electronics device and, if so, establishing the wireless data communications link with that candidate electronics device.

29. A method of controlling an apparatus so as to establish a wireless data communications link between the apparatus and an electronics device, wherein the apparatus comprises a camera and a wireless communications interface, the method comprising:
controlling the camera to capture an image;
receiving a selection of a part of the image, the selected part representing a selected electronics device; and
controlling the wireless communications interface to establish a wireless data communications link with the selected electronics device.

30. The method of claim 29, wherein controlling the wireless communications interface to establish the wireless data communications link with the selected electronics device comprising steering a radio-frequency beam generated by the wireless communications interface towards the selected electronics device.

31. The method of claim 29, wherein controlling the wireless communications interface to establish a wireless data communications link with the selected electronics device comprises:
detecting one or more candidate electronics devices; and
for one or more of the one or more candidate electronics devices:
sending a request to one of the candidate electronics devices to request a visual signal from the candidate electronics device;
using the camera to detect the visual signal;
determining whether the detected visual signal corresponds to the selected electronics device and, if so, establishing the wireless data communications link with that candidate electronics device.

32. A computer program which, when executed by a processor, causes the processor to carry out a method according to any one of claims 29 to 31.
